(19) United States
(12) Patent Application Publication
(10) Pub. No.: US 2015/0087408 A1
(43) Pub. Date: Mar. 26, 2015

(54) Electronic Voucher Ticket System

(71) Applicant: JCM American Corporation, Las Vegas, CA (US)

(72) Inventors: Robert Siemasko, Las Vegas, NV (US); Yuichiro Tsutsui, Tokyo (JP)

(73) Assignee: JCM AMERICAN CORPORATION, Las Vegas, NV (US)

(21) Appl. No.: 14/494,629

(22) Filed: Sep. 24, 2014

Related U.S. Application Data
(60) Provisional application No. 61/881,929, filed on Sep. 24, 2013.

(51) Int. Cl. G07F 17/32

(52) U.S. Cl. CPC G07F 17/3251
USPC 463/25

(57) ABSTRACT

A clearinghouse system for use is transferring a value of a first voucher ticket issued by and associated with a first gaming facility to a second voucher ticket associated with a second gaming facility. The voucher ticket can be provided on paper or in electronic or digital format. The clearing house can deduct a fee for the conversion. The voucher ticket can include a coded machine readable image representing either a serial number or a financial value. The coded machine readable image can be encoded using an encoding scheme that is proprietary to the voucher ticket issuing party. The clearinghouse is in communication with each ticket voucher database of each respective gaming facility to appropriately revise the database with any impact from the transaction transferring the value from one voucher ticket to a second voucher ticket.

### CROSS-REFERENCE TO RELATED APPLICATIONS

This application claims the benefit of U.S. Provisional Patent Application No. 61/881,929, filed on Sep. 24, 2013.

### FIELD OF INVENTION

This invention relates to a clearinghouse system for use with electronic vouchers issued by casino systems via electronic gaming machines (EGMs).

### BACKGROUND OF THE INVENTION

Ticket vouchers are utilized in the gaming industry for transactions. The ticket vouchers include information required to complete secured transactions, including coded data provided in any suitable format, such as barcodes. Typically, a player will cash out after completing the gaming play, and the gaming machine will print a voucher ticket. The voucher ticket is identified by a voucher ID that is issued and managed by the casino voucher ticket system. The voucher ID is printed in a barcode and is associated with a printed validation code printed on the voucher ticket. The voucher ticket received by the player can be inserted into a second gaming machine to credit the machine or can be inserted into a payment kiosk to receive cash that is equivalent to the value of the printed voucher ticket.

Each property issues its own proprietary form of these voucher tickets. Therefore, a gaming patron playing games at a variety of casino properties will be issued voucher tickets from each of the variety of properties; each voucher ticket is property-specific so cannot be used at another property. The gaming patron must keep track of these numerous voucher tickets from different properties.

As previously mentioned, the ticket vouchers are limited for use with one gaming company, and generally, limited for use with one specific facility. To ensure security, the ticket vouchers are commonly encoded to a financial system that is proprietary to the gaming facility. The proprietary encoding is one method, which restricts the use of the ticket voucher to the associated issuing gaming facility. When the user desires to leave one gaming facility to play at a different gaming facility, this constraint imposes a requirement upon the user to cash in the ticket voucher prior to leaving the current gaming facility.

An object of the present invention is to provide a clearinghouse to manage vouchers from multiple properties. A multi-property clearinghouse has been proposed that connects the back end voucher servers from different properties. This proposal provides a solution to the user for converting a ticket voucher issued by a first gaming facility to a ticket voucher that would be accepted for use at a second gaming facility. However, this solution would require the cooperation of the multiple properties and of gaming regulators.

### BRIEF SUMMARY OF THE INVENTION

The electronic payment system according to the present invention comprises a payment system for use in conjunction with automated gaming machines. The payment system enables completion of a financial transaction using an automated payment system integrated into the automated gaming machine. The automated payment system can be configured to accept paper currency, coins, credit cards, gaming facility issued cards, ticket vouchers, and the like. The ticket vouchers include a machine readable code and can be presented as a printed document, an image displayed upon a portable computing device (such as a smartphone, a tablet computer, a personal data assistant, a portable electronic gaming device, a proprietary gaming company issued computing device, and the like), and the like.

In accordance with one embodiment of the present invention, the invention includes a method of transferring a value of a first gaming facility issued ticket voucher to a second gaming facility issued voucher, wherein the first gaming facility is independent of the second gaming facility, the method comprising the steps:

obtaining an originating voucher ticket having a financial value and an originating voucher ticket reference for determining said financial value, wherein said voucher ticket is issued by and associated with a first gaming facility;

storing said originating voucher ticket financial value and said originating voucher ticket reference on a first gaming facility financial server;

reading said reference from said originating voucher ticket;

determining said financial value of said originating voucher ticket by using said reference read from said originating voucher ticket and communicating with said first gaming facility financial server;

entering a desired second issuing gaming facility, wherein said second issuing gaming facility differs from said first gaming facility; establishing a reference associated with a financial value of a replacement voucher ticket;

storing said replacement voucher ticket financial value and said replacement voucher ticket reference on a second gaming facility financial server;

issuing said replacement voucher ticket comprising said replacement voucher ticket reference.

In a second aspect, the ticket voucher includes a machine readable image, wherein the machine readable image provides a financial value associated with the ticket voucher.

In another aspect, a value associated with each ticket voucher is recorded on a financial system database.

In another aspect, a serial number or other reference and a value associated with each ticket voucher are recorded on a financial system database. The serial number or other reference can be a numeric arrangement, an alpha-numeric arrangement, and can include or exclude additional ASCii characters.

In another aspect, the ticket voucher includes a machine readable image, wherein the machine readable image provides a serial number, wherein the serial number is associated with the financial value and the financial value is determined by submitting an inquiry and obtaining a result from a financial system database.

In yet another aspect, the ticket voucher can include a machine readable image further comprising at least one of: a financial value of the associated ticket voucher, an issue date, an expiration date, a name of the associated gaming facility, a logo of the associated gaming facility, a serial number identifying the ticket voucher, and the like.

In yet another aspect, the machine readable image is printed upon a paper substrate forming a paper ticket voucher.

In yet another aspect, the machine readable image is downloaded to a portable computing device in a form of a digital image and presented as an image on a display panel.

In yet another aspect, the machine readable image presented on a first ticket voucher associated with a first gaming facility is read and decoded determining an associated financial value and the financial value is transferred to a replacement ticket voucher associated with a second gaming facility.

In yet another aspect, the machine readable image presented on a first ticket voucher associated with a first gaming facility is read and decoded determining an associated a financial value and the financial value is transferred to a replacement ticket voucher associated with a second gaming facility, wherein the revised associated financial values are electronically communicated to each of the respective gaming facility financial systems.

In yet another aspect, the machine readable image presented on a first ticket voucher associated with a first gaming facility is read and decoded determining an associated financial value and the financial value is transferred to a replacement ticket voucher associated with a second gaming facility, wherein the first ticket voucher is provided in a first form factor and the second ticket voucher is provided in a second form factor and the first form factor differs from the second form factor.

In yet another aspect, each machine readable image is encoded and deciphered in accordance with a security encoding schematic provided by the respective gaming facility.

In yet another aspect, the ticket voucher further comprises a human legible image presenting of at least one of a financial value of the associated ticket voucher, an issue date, an expiration date, a name of the associated gaming facility, a logo of the associated gaming facility, a serial number identifying the ticket voucher, and the like.

In yet another aspect, the present invention further comprises a method of cashing out at least a portion of the ticket voucher. In one embodiment, a balance of the ticket voucher can be provided to the user by a newly issued ticket voucher associated with the same associated gaming facility. Alternatively, the balance of the ticket voucher can be transferred to a newly issued replacement ticket voucher associated with the second gaming facility.

In yet another aspect, the method further comprises a step of validating authenticity of the ticket voucher by submitting an inquiry to the financial system database.

In yet another aspect, the method further comprises a step of obtaining information from the ticket voucher using a digital imaging system integrated into the ticket voucher reader.

In yet another aspect, the method further comprises a step of obtaining information from the ticket voucher using wireless signal communication between a ticket voucher reader and the portable computing device.

These and other aspects, features, and advantages of the present invention will become more readily apparent from the attached drawings and the detailed description of the preferred embodiments, which follow.

### BRIEF DESCRIPTION OF THE DRAWINGS

The above-mentioned and other objects and advantages of the present invention will be apparent from the following description in connection with the accompanying drawings showing gaming machines as preferred embodiments of the electronic payment system of the invention wherein:

FIG. 1 presents an exemplary schematic diagram illustrating a basic concept of the electronic payment system according to the present invention;

FIG. 2 presents a schematic diagram illustrating an exemplary embodiment of a gaming machine of prepaid card transaction type in accordance with the present invention;

FIG. 3 presents a schematic diagram detailing an exemplary cash to electronic voucher ticket (eV/T) process, initiating play at the electronic gaming machine;

FIG. 4 presents a schematic diagram detailing an exemplary paperless electronic voucher ticket (eV/T) process; and

FIG. 5 presents a schematic diagram detailing an exemplary electronic voucher ticket (eV/T) cash out process, terminating play at the electronic gaming machine.

FIG. 6 presents a schematic diagram illustrating an exemplary electronic financial system utilizing printed ticket vouchers and/or electronic ticket vouchers;

FIG. 7 presents a schematic diagram illustrating an exemplary arrangement of an electronic financial server;

FIG. 8 presents a first portion of a flow diagram illustrating an exemplary electronic financial process flow, more specifically an initiation portion of the process;

FIG. 9 presents a second portion of a flow diagram illustrating an exemplary electronic financial process flow, more specifically an electronic money management mode thereof;

FIG. 10 presents a schematic diagram illustrating an exemplary e-money processing system integrated into a bill validator system;

FIG. 11 presents a schematic diagram illustrating an exemplary e-money processing system integrated into a gaming machine;

FIG. 12 presents a schematic diagram illustrating an exemplary externally located e-money processing system in communication with a gaming machine;

FIG. 13 presents a schematic diagram illustrating an exemplary automated printed ticket voucher currency exchange machine;

FIG. 14 presents a schematic diagram illustrating an exemplary printed ticket voucher clearing house exchange system;

FIG. 15 presents a schematic diagram detailing an exemplary physical printed ticket voucher clearing house exchange system;

FIG. 16 presents a schematic diagram detailing an exemplary physical printed ticket voucher clearing house printed replacement system;

FIG. 17 presents a schematic diagram detailing an exemplary electronic ticket voucher clearing house exchange system; and

FIG. 18 presents a schematic diagram detailing an exemplary voucher ticket to electronic voucher ticket conversion process utilizing the clearing house exchange system

### BEST MODE FOR CARRYING OUT THE INVENTION

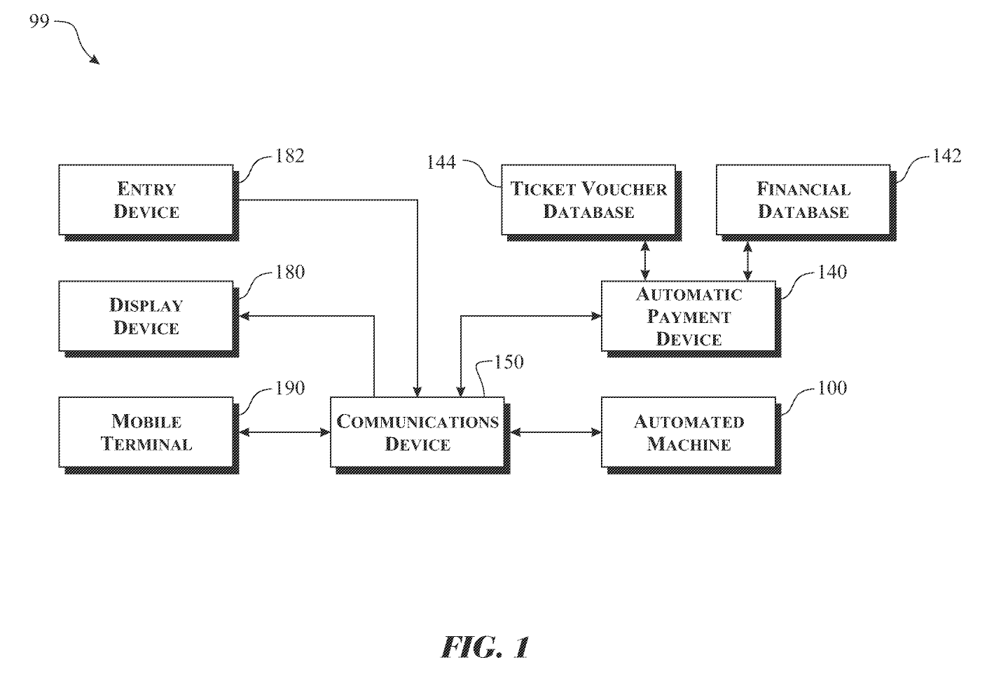

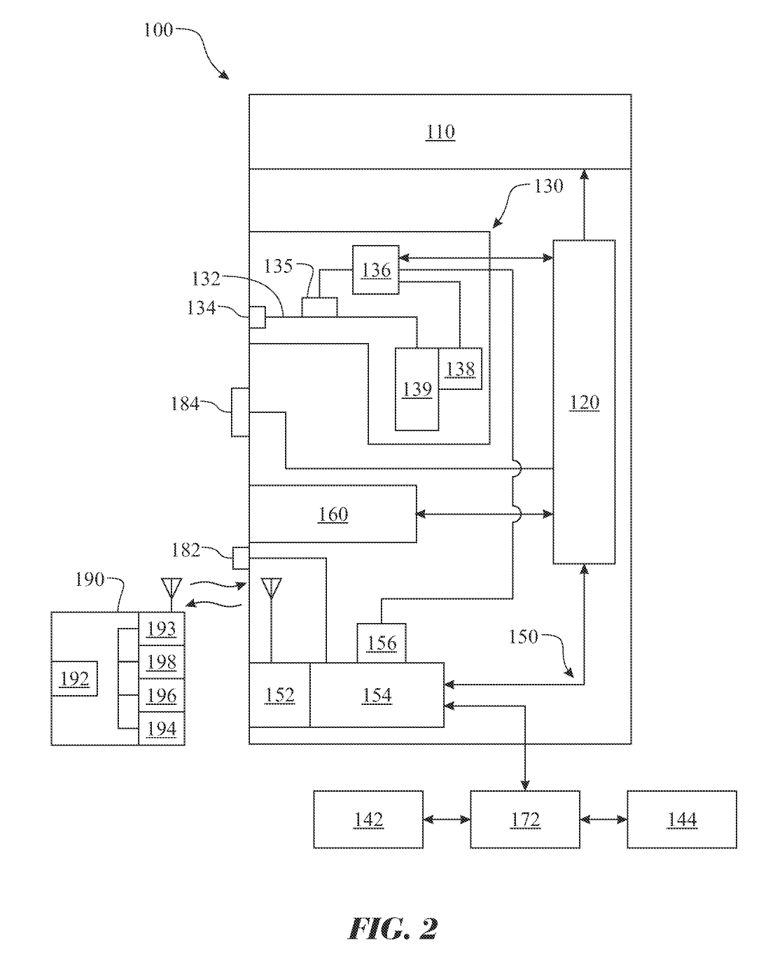

A basic concept of an electronic payment system 99, according to the present invention, is presented in FIG. 1 with details of a portion of the components being presented in FIG. 2. The exemplary electronic payment system 99 comprises a mobile terminal 190 for emitting and/or receiving a remotely operable signal that may include information on a specific or unique account number or a debit card number associated with a financial database 142. The unique account number or a debit card number identifies an account owned by a holder thereof. The electronic payment system 99 also comprises a communications device 150 provided in signal communication with an automated machine 100 for receiving a remotely operable signal emitted from the mobile terminal 190. The communications device 150 can also receive a monetary signal indicative of a transaction fee necessary to drive the automated machine 100 simultaneously with, before, or after receiving the remotely operable signal. When the remotely operable signal contains a monetary signal, the communications device 150 can receive the encoded information respective to account number and the monetary signal contained in the remotely operable signal transmitted from the mobile terminal 190. Alternatively, the monetary signal can be produced and transmitted to the communications device 150 by another signal input device such as an entry device 182, which will be described below. The holder of the financial account usually is a same individual that owns the mobile terminal 190, however, the holder might be a different person from the owner of the mobile terminal 190. The mobile terminal 190 can be any portable computing device comprising a wired or wireless communication system compatible with the communication system and respective protocol of the communications device 150.

Then, the communications device 150 may retrieve the holder's account number from the financial database 142 and the monetary signal if they are contained in the remotely operable signal. The electronic payment system 99 may also comprise an automatic payment device 140 linked to the financial database 142 for receiving a transmitted signal from the communications device 150, the holder's account number signal from the financial database 142 and the monetary signal of the transaction fee and for withdrawing an amount of transaction fee from the correct holder's account at the financial database 142 to produce an authorization signal, wherein the authorization signal is only provided in a condition where the received account number is correct and the amount of transaction fee is within a deposit balance of the account. Upon receipt of the authorization signal, the communications device 150 produces a monetary signal to the automated machine 100 to drive it at the amount equivalent to a value of received monetary signal.

The mobile terminal 190 may emit a remotely operable signal, such as a radio or other wireless signal; an optical beam signal of infrared, ultraviolet or visible ray; and the like, to interact with the remotely operable signal by communications device 150. The mobile terminal 190 and communications device 150 are electrically connected to each other through a wired or a wireless mutual communication interface for radio or optical connection. The mobile terminal 190 also may include a cellular phone, a smart phone utilizing wireless application protocol (WAP), a personal digital assistant (PDA), a portable computer, a hand held computer for electronic payment through the debit or prepaid card transaction system, or the like. A debit card transaction system may include J-Debit, VISA Debit and Debit Master. Prepaid card transaction systems may include Eddy, Suica, PASMO, nanaco, and WAON. The aforementioned systems and devices are exemplary and the mobile terminal 190 may comprise ones for other electronic payment systems 99 or devices. Also, the mobile terminal 190 may be an electronic computer terminal or a smart card, chip card, or integrated circuit card (commonly referred to as an IC card) that incorporates a built-in non-contact IC chip such as for example FeliCa (Registered Mark), MIFARE (Registered Mark) or NFC (Near Field Communication) chips.

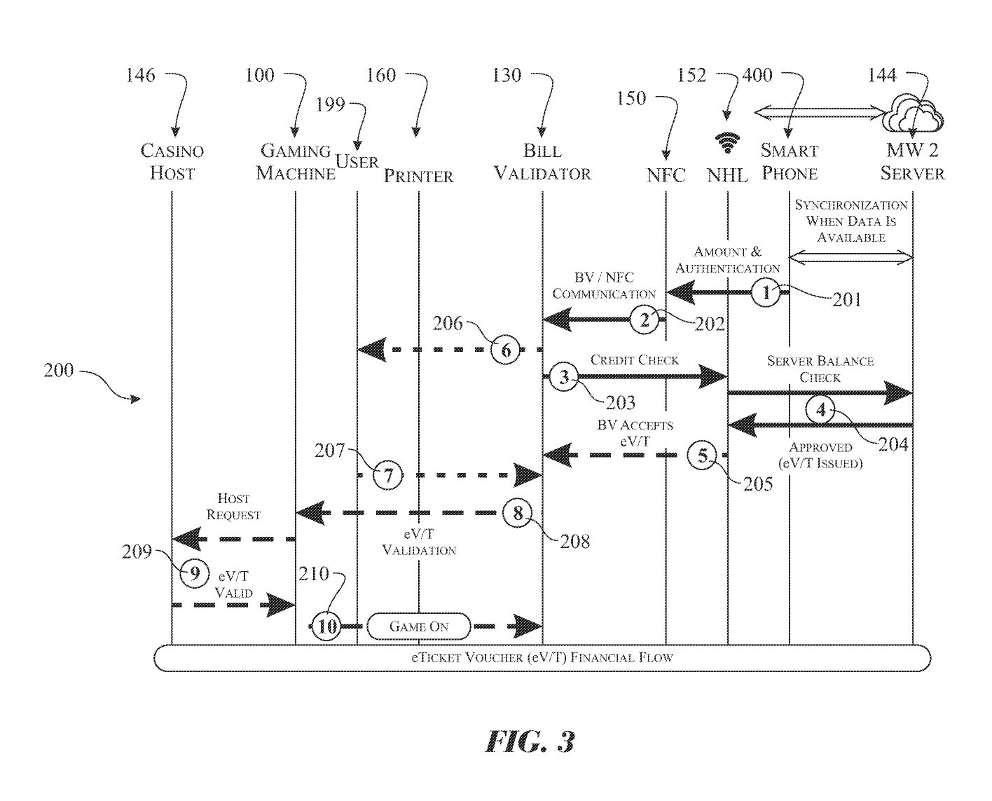

The automatic payment device 140 can additionally incorporate elements for reading and generating ticket vouchers 310, 410 (FIG. 3). The ticket vouchers 310, 410 can be in any suitable form factor, including a paper voucher ticket 310 and an electronic voucher ticket 410. The information associated with the ticket voucher 310, 410 would be obtained using elements respective to the form factor of the ticket voucher 310, 410. For example, the automatic payment device 140 would include a scanner for reading a paper voucher ticket 310 and/or a camera for reading an image displayed upon an electronic voucher ticket 410. An additional option would be the use of the mobile terminal 190 to wirelessly communicate with a portable computing device 400 (FIG. 3) to provide a wireless communication interface therebetween to obtain data associated with the electronic voucher ticket 410.

Details of the mobile terminal 190 are presented in FIG. 3. The mobile terminal 190 comprises a digital storage device 193 such as an integrated digital storage media, a removable digital storage, or both. The digital storage device 193 can be provided in any suitable format, including a memory card, flash memory, and the like removably insertable or integrated within a cellular phone for storing code information that includes an account number of a holder's debit or prepaid card, PIN (Personal Identification Number) and/or ID (Identification) number, a user entry device 194 such as a physical numerical keypad, a physical keyboard, a graphical user interface generated numerical keypad or alpha-numeric keypad in cellular phone for inputting an amount of a transaction fee signal such as gaming fees into digital storage device 193, a Central Processing Unit (CPU) 192 electrically connected to all electronic circuits and electronic functional systems for preparing a remotely operable signal inclusive of the code information stored from digital storage device 193, the wireless transmitting system 196 for transmitting remotely operable signal from CPU 192 to communications device 150, the wireless signal receiving system 198 for receiving a deal signal from the communications device 150 when communications device 150 transmits to mobile terminal 190 the deal signal produced by communications device 150, and a portable power supply (such as a battery, super capacitor, and the like), (not shown) for supplying electric power to each electrically operated device or circuit to perform the various reading, writing, transmitting and receiving functions in mobile terminal 190. The digital storage device 193 does not need to store the code information for enhancement in security as any code signals may be produced by user entry device 194 and transmitted outside through wireless transmitting system 196. A single convertible transceiver circuit can be used for both the transmission and reception functions 196, 198. The CPU 192 can prepare the remotely operable signal that contains a transaction fee signal and a code signal inclusive of account number of debit or prepaid card, a PIN (Personal Identification Number) and/or an ID (Identification) number.

Returning to FIG. 1, there are a variety of automated machines for receiving transaction fee signal from the communications device 150, wherein the automated machines may include automated teller machines (ATM), vending machines, money exchangers, gaming machines, or other money-operated equipment or apparatus. The present invention adopts a gaming or automated machine 100 as an example of automated machines, however, it would be apparent to ordinary skill in the art that the electronic payment system 99 of the present invention can also apply to drive other financially driven, automated machines in a similar way.

The communications device 150 and automatic payment device 140 are electrically linked to each other through a wired, a wireless connection, an Intranet connection, an Internet protocol, or any combination thereof. The automatic payment device 140 and the financial database 142, such as banking systems are linked to each other through a wired, a wireless connection, an Intranet connection, an Internet protocol, or any combination thereof. In embodiments of the present invention, the communications device 150 can be disposed within, outside of, or adjacent to the gaming or automated machine 100 so far as users may operate the mobile terminal 190 to access communications device 150 in the vicinity of or at a location not too distant from the gaming or automated machine 100. Both the communications device 150 and the automatic payment device 140 may be disposed within or outside of the gaming or automated machine 100 for any spatial reason, so far as users may easily access the gaming or automated machine 100 and operate the communications device 150. For a similar reason, one of the communications device 150 and the automatic payment device 140 can be disposed within or outside of gaming or automated machine 100 so far as they may be provided in signal communication with one another.

The communications device 150 comprises a signal processor 154 connected to automated machine 100 for retrieving and producing an account number that identifies a holder of the account at financial database 142 and if necessary holder's PIN and/or ID numbers and monetary signals from remotely operable signal received from mobile terminal 190, and a communications interface 152 for intervening telecommunication between mobile terminal 190 and signal processor 154.

A typical example of the automated machine applied to a schematically depicted gaming or automated machine 100 is illustrated in FIG. 2. The gaming or automated machine 100 comprises a bill acceptor 130, a drive device 120 connected to the communications device 150, and to gaming hardware 110 and a printer 160 for recording game information on a recording medium. The bill acceptor 130 validates a bill inserted therein from outside to produce a bill monetary signal to drive device 120 as a monetary signal of transaction fee when bill acceptor 130 decides that the inserted bill is genuine. The drive device 120 generates drive signals of the amount equivalent to a value of received monetary signal to present games when receiving each monetary signal from the bill acceptor 130. The drive signals are forwarded to the gaming hardware 110. The printer 160 prints onto a recording medium, data of the game information, money amount to be refunded and management codes to issue the recording medium as a coupon.

The bill acceptor 130 comprises an inlet sensor 134 for producing a detection signal when a bill is inserted into bill acceptor 130, a bill sensor 135 for producing a characteristic signal inclusive of an optical or magnetic signal when a bill is moved along bill sensor 135, a conveyor (not shown) for transporting a bill along a passageway 132 in bill acceptor 130 and a control device 136 for receiving detection signal from inlet sensor 134 and characteristic signal from bill sensor 135 to produce drive signals to conveyor when control device 136 considers the bill as being genuine. Specifically, control device 136 may verify whether or not the bill is genuine and what kind of denomination the bill has, and when it decides that the bill is genuine, the control device 136 generates a denomination signal of the bill as a digital monetary signal, wherein the signal is communicated to the drive device 120. On the other hand, the control device 136 also receives from the communications device 150, the monetary signal sent from the mobile terminal 190, and so, transmits to the drive device 120 either of the monetary signals that bill acceptor 130 produces and relays from the communications device 150. The control device 136 is provided in electrical communication to a converter 156 of the communications device 150 for converting the denomination signal from the signal processor 154 into a serial denomination signal and transmitting the serial denomination signal to the control device 136 of the bill acceptor 130. The control device 136 has a memory area for storing a specific code, such as an electronic serial number, identifying the specific gaming or automated machine 100 and also storing both monetary signals that the bill acceptor 130 produces and relays from the communications device 150. Otherwise, the present invention also contemplates that the bill acceptor 130 can validate valuable coupon tickets, scrip, tender, tokens or substitutes of bills.

The bill acceptor 130 validates a bill inserted from outside to produce a monetary signal representative of the valuation of the bill to the drive device 120 when the bill acceptor 130 determines the value of the inserted bill and that the inserted bill is genuine. The bill acceptor 130 also receives a monetary signal contained in the remotely operable signal from the signal processor 154 through the converter 156 of the communications device 150, and forwards the monetary signal to the drive device 120. Then, the drive device 120 receives either of the monetary signals from the bill acceptor 130 to generate to the gaming hardware 110 the drive signals having the amount equivalent to a value of either of the received monetary signal(s) to allow the gaming hardware 110 to conduct a game. Each of monetary signals may indicate a financial value corresponding to one or more denominations of bills optically or magnetically readable by the bill acceptor 130. In other words, the financial value or money amount to be transmitted may be selected from amounts in denominations of bills readable by the bill acceptor 130. By way of example, when the bill acceptor 130 can selectively validate bills of five kinds, i.e. one-dollar, five-dollar, ten-dollar, twenty-dollar or one hundred-dollar bills, it would be preferable to send signals of the amount selected from one-dollar, five-dollar, ten-dollar, twenty-dollar or one hundred-dollar bill from the mobile terminal 190 to the communications device 150.

The drive device 120 can generate to the gaming hardware 110, drive signals having the amount equivalent to a value of the received monetary signal when receiving the monetary signal through the bill acceptor 130. Otherwise, the communications device 150 may forward the monetary signal of the transaction fee directly to the drive device 120 without the bill acceptor 130 so that the drive device 120 may produce to the gaming hardware 110 the respective drive signals having the amount equivalent to the amount of transaction fee to drive the gaming hardware 110 by drive signals from the drive device 120. This allows users to select either a cash payment or a cashless electronic payment for gaming in amusement halls or casinos.

The bill acceptor 130 also comprises a stacker 139 for accommodating bills considered genuine by the control device 136, and a memory device 138 in electrical communication with the control device 136 and attached to the stacker 139 for storing monetary or denomination signals, account number signals, PIN and ID number signals and specific code signal identifying the gaming or automated machine 100 forwarded from the control device 136. The control device 136 distinctively stores in the memory area both monetary signals produced by the control device 136 and transmitted from the communications device 150. The memory device 138 distinctively stores both monetary signals transmitted from both the control device 136 and the communications device 150, account number signals, PIN and ID number signals and specific code signal identifying the gaming or automated machine 100; all forwarded from the control device 136. The bill acceptor 130 is removably attached to the gaming or automated machine 100 and also the stacker 139 is removably attached to the bill acceptor 130 to easily take out and collect bills accumulated within the stacker 139. Accordingly, when the bills accumulated within the stacker 139 are to be collected, the bill acceptor 130 is detached from gaming or automated machine 100 and then the stacker 139 is removed from the bill acceptor 130.

In operation, when the mobile terminal 190 moves closer to the communications device 150, the mobile terminal 190 emits a radio signal inclusive of the account number signal of financial database 142 identifying a holder of the account and transaction fee signal to be paid for operation of gaming or automated machine 100. Subsequently, the communications device 150 receives a radio signal to retrieve the holder's account number embedded within the radio signal and also receive a monetary signal indicative of the transaction fee that may be involved in the radio signal. Alternatively, the communications device 150 may be connected to an entry device 182 for inputting a monetary signal of a transaction fee for the gaming or automated machine 100 to transmit monetary signal from the entry device 182 to the communications device 150. Then, the automatic payment device 140 can receive monetary signal from the entry device 182 through the communications device 150 simultaneously with, before, or after receiving the radio signal from the mobile terminal 190. Then, just like through an on-line debit or prepaid card system, the automatic payment device 140 can withdraw the financial equivalent of the transaction fee from the holder's account at the financial database 142 when the amount of transaction fee is within a deposit balance of the holder's account. Then, the automatic payment device 140 produces an authorization signal to the communications device 150 that then sends the monetary signal to the gaming or automated machine 100 to drive it.

In another embodiment of the present invention, remotely operable signal may include PIN and/or ID numbers to more strictly identify the holder in addition to the holder's account number of the mobile terminal 190 to increase security against unauthorized access to the holder's account. When the mobile terminal 190 emits a radio signal inclusive of account number and PIN and/or ID number, the communications device 150 can receive the radio signal, retrieve or decipher the account number, the PIN and/or ID numbers from the radio signal and withdraw the amount of transaction fee from the holder's account at the financial database 142 when PIN and/or ID numbers correspond to one or ones of pass-codes or secret numbers stored within the financial database 142. In lieu of the PIN and/or ID number included in radio signal, the entry device 182 can be used to produce the PIN and/or ID number signals from the entry device 182 connected to the communications device 150 to provide them to the automatic payment device 140 through the communications device 150 so that the automatic payment device 140 can withdraw the amount of transaction fee from the holder's account at the financial database 142 when the PIN and/or ID numbers correspond to one or ones of pass-codes or secret numbers at financial database 142.

In a further embodiment of the instant invention, the communications device 150 can be connected to a visual and/or acoustic display device 180. When communications device 150 receives an authorization signal from the automatic payment device 140, the communications device 150 produces and transmits a deal signal to the mobile terminal 190 and/or to the display device 180 to exhibit the deal signal thereon. On another aspect, when the communications device 150 fails to retrieve the account number embedded within the radio signal or retrieves an incorrect account number, the automatic payment device 140 produces an unauthorized signal to the communications device 150 that, then produces and forwards a no-deal signal to the mobile terminal 190 and/or to display device 180 for exhibition of no-deal signal.

For example, when the drive device 120 has completed its program-controlled operation or when a force-quit button 184 is actuated to terminate the game, the drive device 120 generates a refund money signal of an unspent remaining financial balance, award, prize, jackpot, or the like obtained from the game if any. The drive device 120 may transmit a refund money signal and a management code signal to the printer 160 and also to the signal processor 154 of the communications device 150 to store the financial value to be refunded in the signal processor 154. The signal processor 154 may also transmit the refund money signal to the wireless signal receiving system 198 of the mobile terminal 190 through the communications interface 152 so that the mobile terminal 190 may receive and write the refund money signal in the digital storage device 193 of the mobile terminal 190 to add the financial value in the digital storage device 193. The printer 160 may record data as directed by the refund money signal and the necessary management code signals from the drive device 120 on the recording medium or media and prepares a coupon of the recording media for dispensation of the coupon from printer 160. In this way, a mutual intercommunication system may be established to transport and receive electronic signals between the mobile terminal 190 and the signal processor 154 through wired, wireless or radio, optical connection, or the like. Specifically, the communications interface 152 may receive the remotely operable signal from the mobile terminal 190, and transmit it to the signal processor 154 that may receive the remotely operable signal from the communications interface 152. The signal processor 154 can also retrieve and produce signals of the account number or debit card number for identifying the account owner or holder and the holder's PIN and/or ID number and monetary signals or a denomination signal contained in the remotely operable signal and, can then, send the information to the automatic payment device 140.

After or before bills are extracted from the stacker 139, it is put on a readout device 170 as shown in FIG. 3, but the memory device 138 attached to the stacker 139 is retained in the non-contact condition away from the readout device 170 that may be operated to retrieve the following four kinds of information stored in the memory device 138:
(i) Total amount and total number of bills stowed in stacker 139;
(ii) All denomination signals of the bills;
(iii) All account numbers that identify account holders involved; and
(iv) The specific code signal identifying gaming or automated machine 100 from which the stacker 139 has been removed.

The information readout device 170 has retrieved from the memory device 138 is compared with the information of the bills removed from the stacker 139 and with the information from the communications device 150 to inspect whether or not they match.

In still another embodiment, the gaming or automated machine 100 can comprise an entry device made up of a plurality of choice switches, namely an entry device 182 such as image switches (commonly referred to as soft switches or a graphical user interface) on a touch display screen or made up of mechanical selector switches to be chosen to determine a denomination of bills for payment for games so that one or more of choice switches may be selected to determine one or more of different charge amounts to be paid for gaming to transmit one or more charge or denomination signals to signal processor 154 of communications device 150. On the other hand, when mobile terminal 190 transmits to the communications device 150 remotely operable signal including holder's account number signal, the communications interface 152 may receive the account number signal from the mobile terminal 190, and the signal processor 154 may receive a chosen charge signal from the entry device 182 and the holder's account number signal transmitted from the mobile terminal 190.

In operation of the gaming or automated machine 100, a user may select either cash or electronic payment as a method for payment for playing games with the gaming or automated machine 100. In order to select the electronic payment option, he or she may operate the user entry device 194 of the mobile terminal 190 to input the money amount of the gaming fees into the Central Processing Unit (CPU) 192 that may synthesize a remotely operable signal by placing on a carrier wave the financial value of the gaming fees and the account number signal stored in the digital storage device 193 and then transmit remotely the operable signal to the communications device 150 through the wireless transmitting system 196. In this way, the user may move closer to the gaming or automated machine 100 and allow the mobile terminal 190 to lightly touch the communications interface 152 while making the mobile terminal 190 produce and transmit the remotely operable signal from the mobile terminal 190.

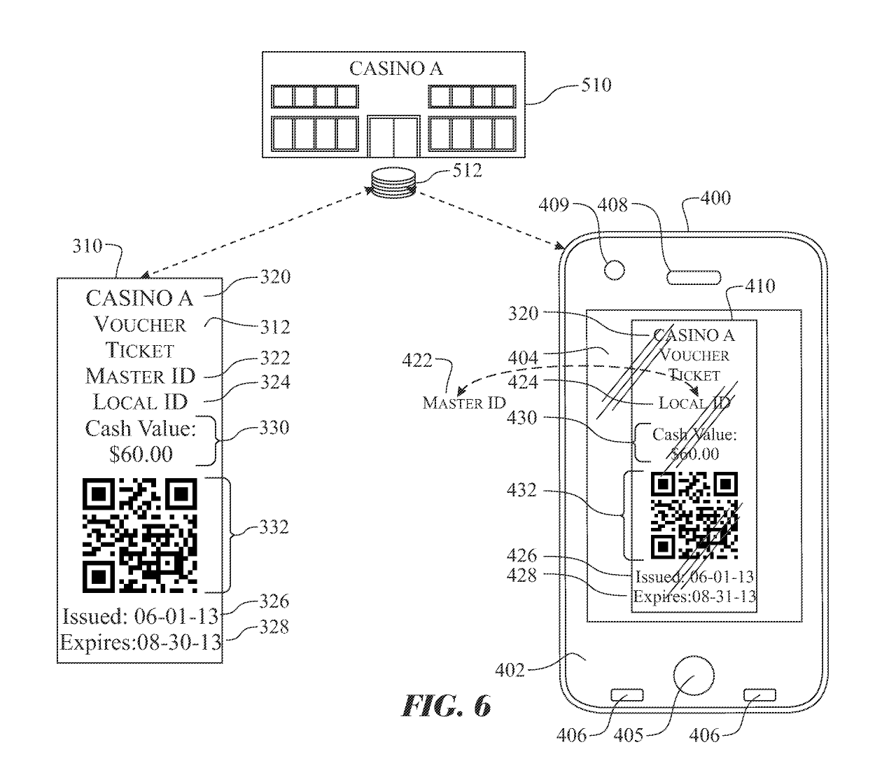

A first financial process flow diagram 200 is presented in FIG. 3. The financial process flow diagram 200 presents a general interaction between contributing elements utilizing an electronic voucher ticket (eV/T in the diagrams) 310, 410 (FIG. 6) for financial processing in conjunction with an electronic gaming machine 100. The various contributing elements include the electronic gaming machine 100, a casino host server 146, at least one printer 160, a bill validator 130 (or other electronic voucher ticket reader), a near field communications device 150, and a mobile wallet server 144. The process initializes with the user 199 submitting a request for tendering payment for credits for use in conjunction with the electronic gaming machine 100. The user 199 enters an amount and necessary information for authorization for the transaction using an application provided on a smartphone 400. The data is received by wireless communication between the smartphone 400 and the near field communicator 150 as indicated by step 201. The near field communicator 150 forwards the information to the bill validator 130 as referenced in step 202. The bill validator 130 completes a credit check or any other associated transaction validation process as indicated by step 203. The system utilizes technology referred to as Network Hub Link (NHL) 158 to communicate with and complete transactions with the mobile wallet server 144. The communication process completes a balance check for available funds and provides feedback to the bill validator 130 as indicated by steps 204 and 205. During this process, an electronic or electronic voucher ticket (eV/T) 410 is issued. In parallel, the bill validator 130 communicates the outcome of the request (accepted or denied) to the user 199 in accordance with step 206. Should the user desire to begin play on the automated machine 100, the user 199 enters the electronic voucher ticket 410 into the bill validator 130 associated with the automated machine 100. The electronic voucher ticket 410 can be read by the bill validator 130 using any suitable technology associated with the form factor of the electronic voucher ticket 410, including a camera to view an electronic voucher ticket 410 displayed upon a smartphone display 404, an near field communicator 150 to read wirelessly transfer information from the smartphone 400, and the like. The automated machine 100 digitally conveys the transaction to the gaming facility host server 446. The gaming facility host server 446 in turn, provides feedback to the automated machine 100 on whether the electronic voucher ticket 410 is accepted or rejected. In a condition where the electronic voucher ticket 410 is accepted, credit is applied to the automated machine 100 and the user 199 begins play thereon.

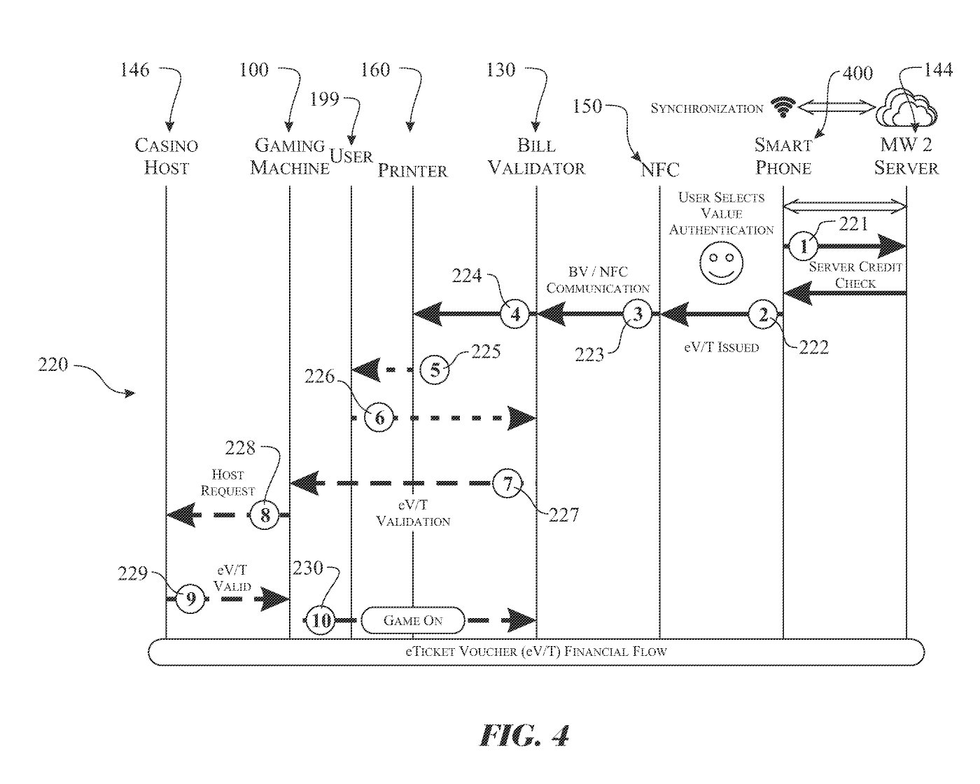

A first alternative process for utilizing mobile wallet is presented in an alternative financial process flow diagram 220 is presented in FIG. 4. The financial process flow diagram 220 presents a general interaction between contributing elements utilizing the electronic voucher ticket (eV/T in the diagrams) 310, 410 (FIG. 6) for financial processing in conjunction with the electronic gaming machine 100. The various contributing elements include those previously described in FIG. 3, excluding the as Network Hub Link (NHL) 158. The process initializes with the user 199 submitting a request for tendering payment for issuance of credits onto the electronic voucher ticket 410 as indicated by step 221. The user 199 enters an amount and necessary information for authorization for the transaction using an application provided on the smartphone 400. The data is received by the mobile wallet server 144 using wireless communication between the smartphone 400 and the mobile wallet server 144. The mobile wallet server 144 issues and forwards the electronic voucher ticket 410 to the smartphone 400 in accordance with step 222. Upon request by the user, the smartphone 400 communicates information associated with the electronic voucher ticket 410 to the bill validator 130 via the near field communications device 150 as indicated by step 223. The bill validator 130 can optionally transfer a request to print a paper voucher ticket 310 (FIG. 6) to the printer 160 as recited in step 224. The paper voucher ticket 310 is dispensed and provided to the user 199. The user 199 enters either the paper voucher ticket 310 or the electronic voucher ticket 410 into the bill validator 130 for use with an associated automated machine 100 as referenced by step 226. The bill validator 130 forwards information directly or indirectly to the gaming facility host server 446 via steps 227 and 228. The gaming facility host server 446 either confirms or rejects a validation of the electronic voucher ticket 410 and reports the validation status (either approved or rejected) to the automated machine 100. In a condition where the electronic voucher ticket 310, 410 is accepted, credit is applied to the automated machine 100 and the user 199 begins play thereon.

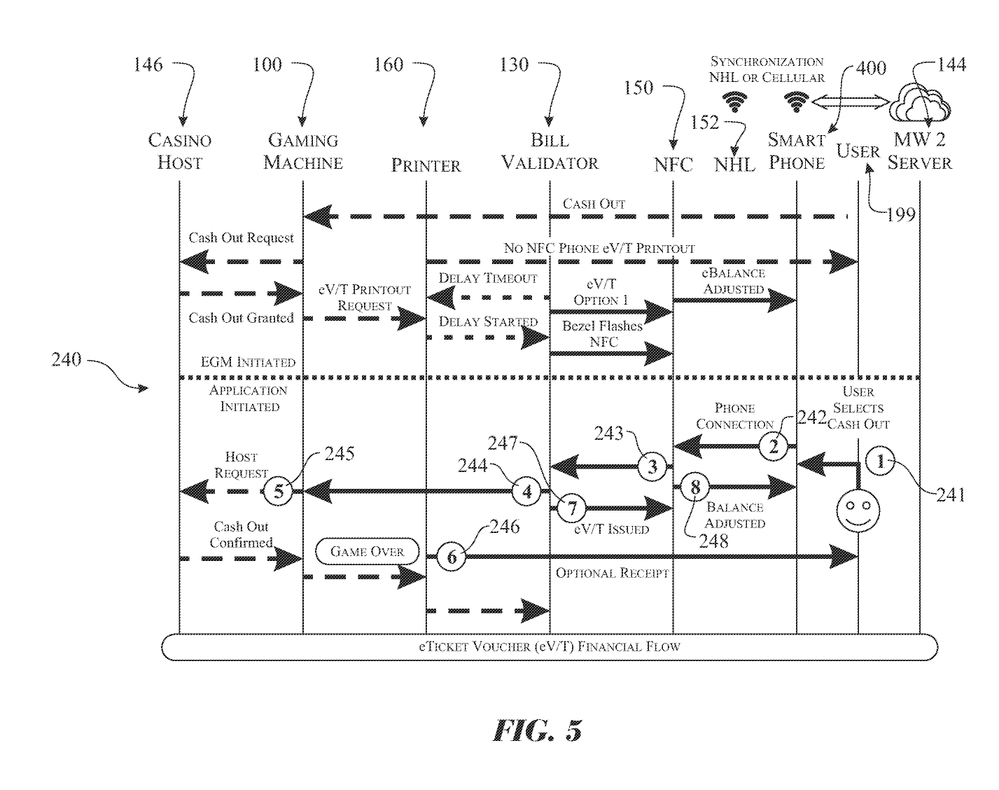

The play can conclude by either a depletion of credits pending in the automated machine 100 or at a request submitted by the user 199. An exemplary electronic voucher ticket (eV/T) cash out process flow diagram 240 is presented in FIG. 5. The financial process flow diagram 240 presents a general interaction between contributing elements for cashing out after play on the automated machine 100. The various contributing elements include those previously described in FIG. 3, wherein the leap forward gaming 158 and the smartphone 400 can be used interchangeably. The process initializes with the user 199 submitting a request for issuance of credits onto the electronic voucher ticket 410 as indicated by step 241. The request is entered using an application on the smartphone 400 via a communication with the near field communications device 150 as recited in step 242. The near field communications device 150 forwards the information via a digital communication link with the bill validator 130 as indicated as step 243. The bill validator 130 forwards the information directly or indirectly to the gaming facility host server 446 in accordance with steps 245 and 245. The gaming facility host server 446, in conjunction with the automated machine 100, tallies any tendered balance, concludes play of the game, and issues a digital electronic voucher ticket 410. The new electronic voucher ticket 410 is forwarded to the near field communications device 150 in accordance with step 247. The new electronic voucher ticket 410 is transferred to the smartphone 400 using near field communication protocol as directed by step 248.

Automated machines 100 can utilize ticket vouchers 310, 410 in conjunction with a financial account server 512 associated with a casino 510 to control and communicate a financial value while a player is within a casino 510 as illustrated in an exemplary schematic diagram presented in FIG. 3. The ticket voucher can be provided as a paper voucher ticket 310 or an electronic voucher ticket 410.

Each voucher ticket 310, 410 would include a computer legible value reference 332, wherein the computer legible value reference 332 can be in any computer readable format, including a barcode, a Quick Read or QR code (as illustrated), and the like. The computer readable value reference 332 is preferably encoded using a protocol that is specific to the respective casino 510. For ease of use, it is desirable that each voucher ticket 310, 410 includes a human legible value reference 330. The human legible value reference 330 would include a human legible financial value of the ticket voucher 310, 410. Each voucher ticket 310, 410 can include additional information suitable for the respective application. The additional information can include a casino identifier 320, a voucher ticket issue date 326 and a voucher ticket expiration date 328. The voucher ticket expiration date 328 is set by a predetermined time period from the voucher ticket issue date 326. The voucher ticket issue date 326 and/or the voucher ticket expiration date 328 is preferably recorded on a voucher ticket database server 512, 522, 532. The paper voucher ticket 310 includes printing applied upon one or both surfaces of a paper voucher ticket substrate 312. The paper voucher ticket 310 can additionally include a master ticket identifier 322 and/or a local ticket identifier 324 for security purposes.

The paper voucher ticket 310 can include a master ticket identifier 322 and/or a local ticket identifier 324, wherein the master ticket identifier 322 is essentially a unique serial code (numeric, alphabetic, or alpha-numeric) utilized in identifying the validity of the paper voucher ticket 310 and the local ticket identifier 324 is a secondary validation code. The local ticket identifier 324 is another identification reference used in conjunction with the paper voucher ticket 310 and assigned to one voucher ticket master identification reference. More specifically, the master and local identification reference has a one-to-one association. The local ticket identifier 324 is assigned by the electronic money management system 512, and used in conjunction with the equipment described herein, is not used at the casino ticket voucher server 512. Because the master identification reference can be redeemable for cash, it is desired to conceal the master identification reference on a smartphone display 404 of a PC or smartphone 400. A local identification reference 324 is employed for the user of the system. The master identification reference 324 is only used when certain messages about the ticket voucher ticket 310, 410 should be sent or received between the ticket voucher server 512 in the casino 510 and the system.

The electronic voucher ticket 410 can be communicated to the smartphone 400 by a wired or wireless communication interface. For reference, the smartphone 400 can comprise common elements associated with a smartphone, a tablet, or any other suitable portable computing device. These elements can include a smartphone display 404 carried by a smartphone housing 402, wherein the smartphone display 404 can be a standard display or more desirably, a touch screen display enabling tactile inputs by the user. The smartphone display 404 presents images from a digital image file. The digital image file would include information to store and display the electronic voucher ticket 410. The elements of the smartphone 400 additionally include a microphone 406 and a speaker 408 for voice communication. At least one Smartphone mechanical user control interface 405 is included providing alternative tactile inputs respective to the smartphone display 404. Advanced portable computing devices include a camera 409 enabling acquisition and storage of digital images. The electronic voucher ticket 410 includes a majority of the same features as the paper voucher ticket 310, wherein like elements of the electronic voucher ticket 410 and the paper voucher ticket 310 are numbered the same except preceded by the numeral ‘4’. The paper voucher ticket 310 is generated by a printing process. The electronic voucher ticket 410 is communicated to the smartphone 400 by any suitable, preferably secure digital data communication protocol. Master information respective to the value and status of the voucher tickets 310, 410 are stored on the respective casino voucher ticket database server 512.

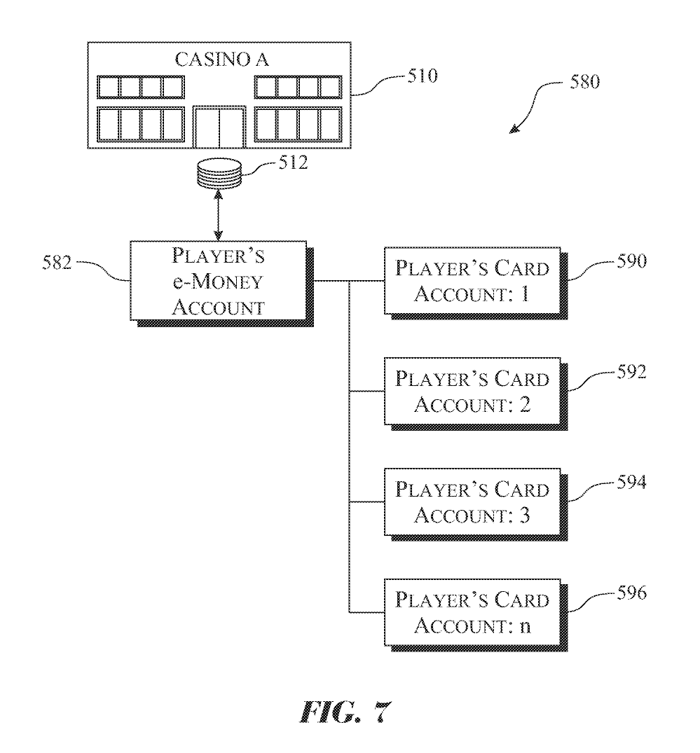

An exemplary e-money or ticket voucher management system 580 is presented in a schematic diagram illustrated in FIG. 7. The casino voucher ticket database server 512 can be organized each player's e-money account 582. Each player's e-money account 582 can be shared across or distributed into each of a plurality of player's cards 590, 592, 594, 596.

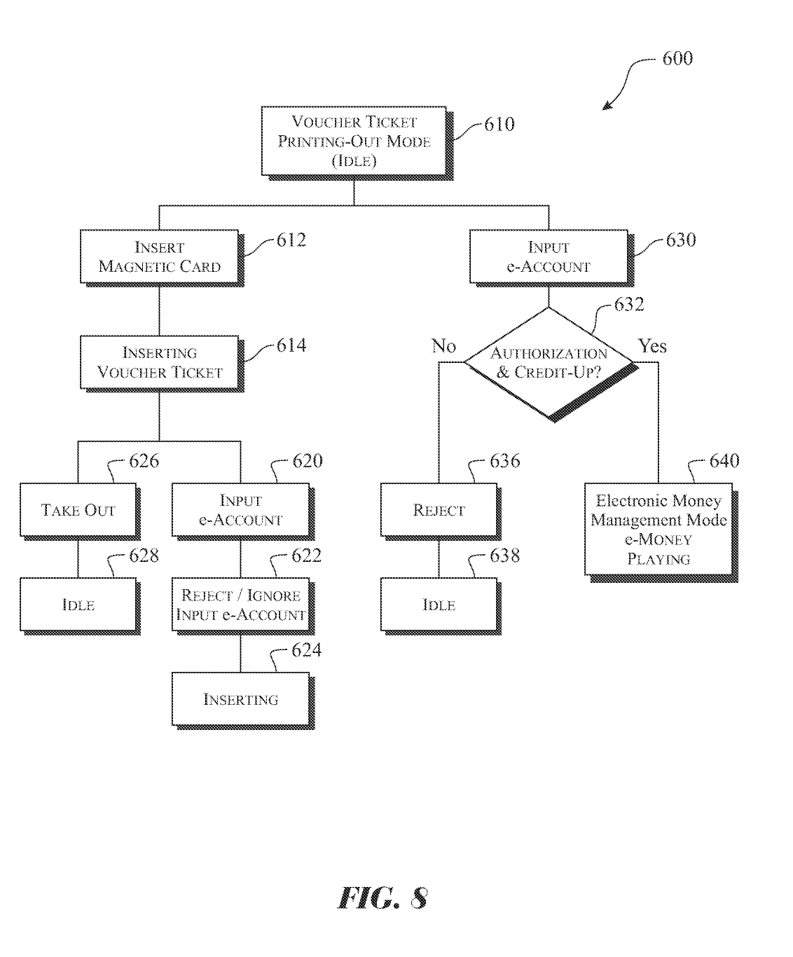

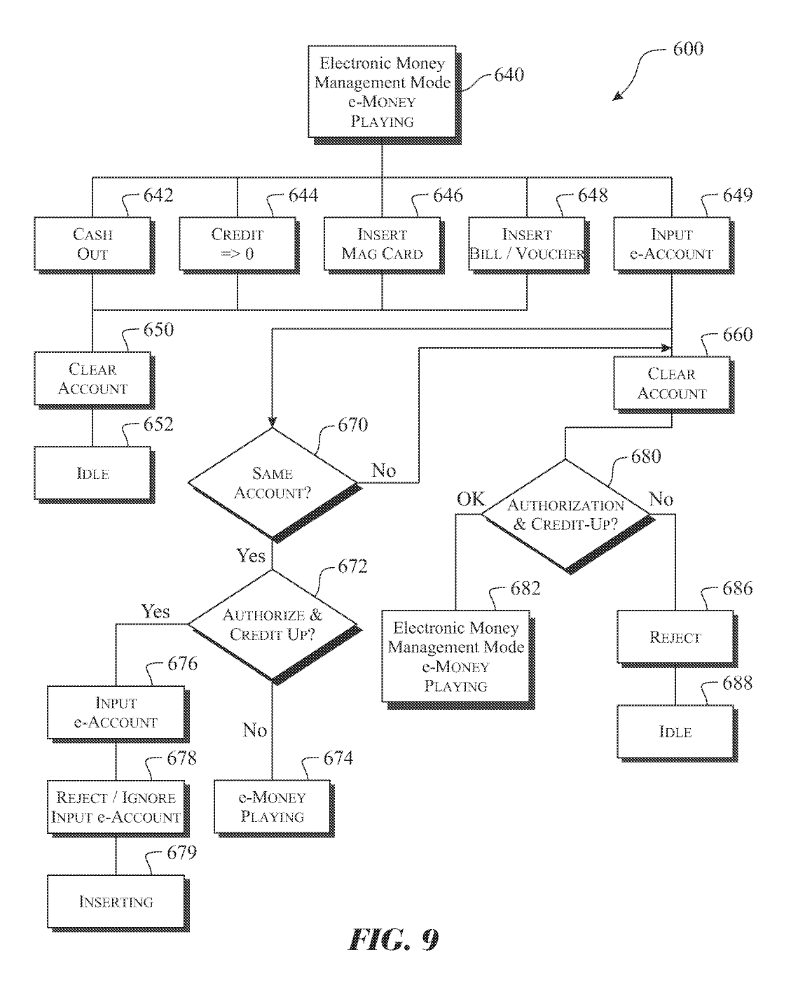

An exemplary electronic financial process flow 600 is presented in two portions, a first portion being presented in FIG. 8, with the process continuing in a second portion being presented in FIG. 9. The process initiates with an issued voucher ticket 310, 410 (step 610). The player initiates use of the gaming machine 100 by selecting the desired mode of operation. The player can initiate an option utilizing the paper voucher ticket 310 or the electronic voucher ticket 410. Initially, the player would identify their player account by informing the gaming machine 100 of such. This can be accomplished by inserting a magnetic card into a player's card slot within the gaming machine 100 (step 612). The gaming machine 100 would convey information obtained from the player's card to the respective casino voucher ticket database server 512 to establish the desired association. The player would prior to, subsequently, or simultaneously insert the paper voucher ticket 310 into the gaming machine 100 (Step 614). The gaming machine 100 would determine the financial or token value of the paper voucher ticket 310 and upload the financial or token value to the gaming machine 100 for play. The player would initiate and continue play on the gaming machine 100 until a desired point of conclusion. At the time of conclusion, the player would request a ticket voucher for any remaining credit or financial value of the game. The player can enter the desired form factor of the voucher from the gaming machine 100. The gaming machine 100 would respond in accordance with the player's instructions. A first option would be to print and dispense a new paper voucher ticket 310 (Step 626). A second option would be to transfer the credit or financial value pending at the point of termination of the game to an e-account (Step 620). The system compares e-account information entered by the player (Step 620) with e-account information stored on the casino voucher ticket database server 512. The system determines if the entered information is consistent with the information stored on the casino voucher ticket database server 512 (Step 622). In a condition where the entered information is consistent with the information stored on the casino voucher ticket database server 512, the system transfers a new electronic voucher ticket 410 to the smartphone 400 (Step 624). In a condition where the entered information is inconsistent with the information stored on the casino voucher ticket database server 512, the system notifies the player with the inconsistency and rejects a request for an e-account transfer.

Alternatively, the player can elect to utilize funds from an e-account. The user enters the e-account information into the gaming machine 100 (Step 630). The system processes the entered information to determine if the entered information is consistent with the information stored on the casino voucher ticket database server 512 (decision Step 632). In a condition where the entered information is consistent with the information stored on the casino voucher ticket database server 512, the system toggles into an electronic money management mode (Step 640). In a condition where the entered information is inconsistent with the information stored on the casino voucher ticket database server 512, the system rejects the request for entry of a financial value (Step 636). The system can direct the player to re-enter the e-account information, request that the player utilize a different source for application of the game fees or simply terminate the process (Step 638).

Details of the electronic money management mode are presented in FIG. 9. The electronic money management mode (Step 640) presents a series of options. The options are based upon the status of play, the current pending credit or financial value retained within the gaming machine 100, and the like. In a condition where the current pending credit or financial value retained within the gaming machine 100 is greater than zero, the player can continue playing (Step 644) or request to cash out (Step 642). The cash out can be accomplished by printing a paper voucher ticket 310 or conveying an electronic voucher ticket 410 to a smartphone 400. The player can insert a magnetic card into the game machine 100 to identify themselves with the game machine 100 as well as the casino voucher ticket database server 512 or other casino financial database server. The player can opt to insert a bill, a paper voucher ticket 310 or the like into the game machine 100 (Step 648). The game machine 100 would apply a credit equaling the value of the entered bill, the entered paper voucher ticket 310, or the like to the total pending credit or financial value stored therein. Upon completion of play, the game machine would disburse a voucher 310, 410 to the player in accordance with the mode selected by the player. The game machine 100 would subsequently clear the account (Step 650) and return to an idle stage (Step 652).

When using an e-account, the player would enter the e-account information (Step 649). The method of entry can vary based upon the options integrated into the game machine 100. The process determines if the e-account information entered into the game machine too is the same as the e-account that has been pending. If the entered e-account information is the same as the e-account currently pending in the game machine too (Step 670), the process continues by requesting entry of an authorization code and application of funds to the gaming machine too. In a condition where the player desired to increase the pending credit value, the player enters the associated e-account and authorization information (Step 676). The entered information is validated against information stored within the e-money or ticket voucher management system 580. In a condition where the entered e-account information is consistent with the information stored on the e-money or ticket voucher management system 580, the system uploads and applies the financial value to the pending credits (Step 679). In a condition where the entered information is inconsistent with the information stored on the e-money or ticket voucher management system 580, the system notifies the player with the inconsistency and rejects a request for an e-account transfer. Wherein the player elects to continue playing with the pending credit, the system continues play using e-money (Step 674).

In a condition where the entered e-account information differs from the e-account information pending in the gaming machine 100, the gaming machine 100 clears the pending account (Step 660) and proceeds requesting the player enter authorization and a financial transaction to apply credits accordingly. The player would commonly proceed by entering the associated e-account and authorization information and proceeding accordingly in an electronic management mode (Step 682).

In a condition where the player rejects this request (Step 686), the gaming machine returns to an idle condition (Step 688).

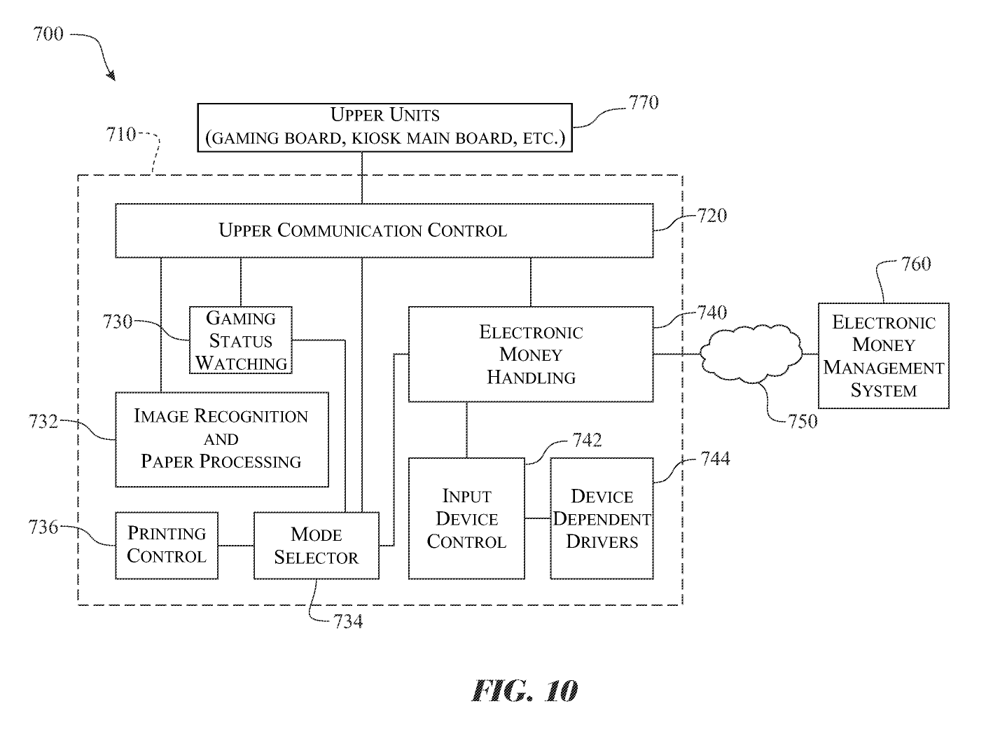

An exemplary bill validator system 700 is illustrated in a schematic diagram format presented in FIG. 10. The bill validator system 700 includes an e-money integrated bill validator structure 710 provided in signal communication with an electronic money management system 760 and a gaming machine operational system 770. The signal communication can be provided using a wired interface or a wireless communication interface, such as a network communications 750. The e-money integrated bill validator structure 710 and gaming machine operational system 770 are preferably integrated into the gaming machine 100, while the electronic money management system 760 can be located at a distance from the gaming machine 100. The gaming machine operational system 770 is representative and can include an electronic gaming main board, a kiosk main board, and the like. The electronic money management system 760 is preferably a centralized system, interfacing with multiple gaming machines 100 using the network communications 750 for communication therebetween.

The e-money integrated bill validator structure 710 includes the necessary components for processing financial transactions, and directing operation of the gaming machine operational system 770. The e-money integrated bill validator structure 710 includes an electronic money handling 740 for receiving, scanning, and stowing bills or other acceptable currency. The electronic money handling 740 is operated by an input control device 742 in conjunction with the respective device dependent drivers 744. The electronic money handling 740 is integrated in signal communication with a mode selector 734 as well as an upper communication control 720. The mode selector enables selective operation of the gaming device 100. This includes operation of the gaming machine 100, the preferred method for accomplishing the financial transactions (using a paper transaction process, using an e-money transaction process, and the like), and any other operational option integrated into the gaming machine 100. The mode selector 734 is provided in signal communication with a printing process control 736, a gaming status watching 730, and the upper communication control 720. The mode selector 734 can be used to establish a condition where the player desires to use either e-money or paper voucher tickets 310. Wherein the player elects to use paper voucher tickets 310, the mode selector 734 activates the printing process control 736. The mode selector 734 can optionally provide a second benefit, wherein the mode selector 734 can be used to manage the gaming status watching 730. The overall management of the e-money integrated bill validator structure 710 is provided by the upper communication control 720. The upper communication control 720 can be integrated into the e-money integrated bill validator structure 710 in a manner establishing signal communication between the upper communication control 720 and one or more of the gaming status watching 730, the image processing and paper processing 732, the mode selector 734, and/or the electronic money handling 740. The upper communication control 720 provides an operational interface between the balance of the components within the e-money integrated bill validator structure 710 and the gaming machine operational system 770. The upper communication control 720 handles the communication process between the e-money integrated bill validator structure 710 and the gaming machine operational system 770 using any suitable standard protocol, including ID003, ID024, ID028, ID0G8, DES encryption, Universal Serial Bus (USB), ICT, SMIB, NISR, USBTAO-V, Pulse or 5V enabled, and the like. The money integrated bill validator structure 710 can include any suitable interface, including pulse, serial (including Universal Serial Bus or USB), parallel, RS232, MDB, CC-Talk, CCNET, GBA, and the like.

The electronic money handling 740 manages the transaction of the electronic money and the voucher ticket information, and handles the communication process with the electronic money management system 760. The electronic money handling 740 manages, holds, releases, and authenticates each respective electronic money account. The electronic money account is specifically referencing a financial account, and more specifically an electronic money account. The electronic money management system 760 would preferably include the arrangement presented in FIG. 4.

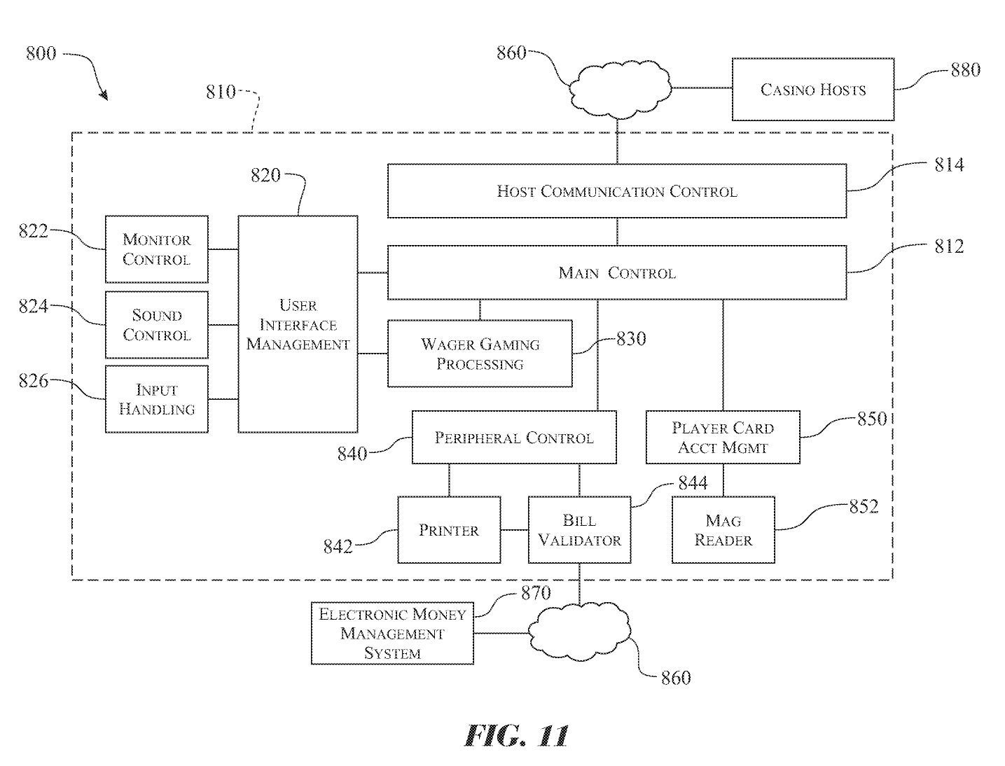

An exemplary gaming machine network 800 is illustrated in a schematic diagram format presented in FIG. 11. The gaming machine network 800 includes a gaming machine configuration 810 provided in signal communication with an electronic money management system 870 and a casino host 880 by way of a network communications 860. The exemplary gaming machine configuration 810 includes a variety of components to provide a gaming machine system having an e-money processing function integrated therein. The e-money integrated bill validator structure 710 utilizes a main controller 812 for governing operation of the gaming machine configuration 810. The gaming machine main controller 812 is provided in signal communication with a host communication controller 814, a user interface management 820, a wager gaming processor 830, a peripheral controller 840, and a player card account management 850. The user interface management 820 provides an interface between the gaming machine main controller 812 and any user interface device, including a monitor controller 822, which provides a visual output and an optional touch screen input function; an audio controller 824, which provides an audible output and an optional audible recording or other input function; and an input management 826, which provides other user entry functions, such as a keyboard, a cursor pointing device, and the like. The wager gaming processor 830 can be integrated into the gaming machine configuration 810, wherein the wager gaming processor 830 is provided in signal communication with both the gaming machine main controller 812 and the user interface management 820. The peripheral controller 840 provides an interface between the gaming machine main controller 812 and peripheral devices, including a printer 842, a bill validator 844, a camera (not shown), and the like. The player card account management 850 provides management functions respective to the player's card account. The player card account management 850 obtains the player's card account information through a magnetic card reader 852.

The network communications 860 is preferably a secured network utilizing an encrypted signal communication protocol. Signal communication between the gaming machine configuration 810 and the electronic money management system 870 is provided through the network communications 860. The electronic money management system 870 provides functionality similar to the electronic money management system 760 previously described. Signal communication between the gaming machine configuration 810 and the casino hosts 880 is also provided through the network communications 860.

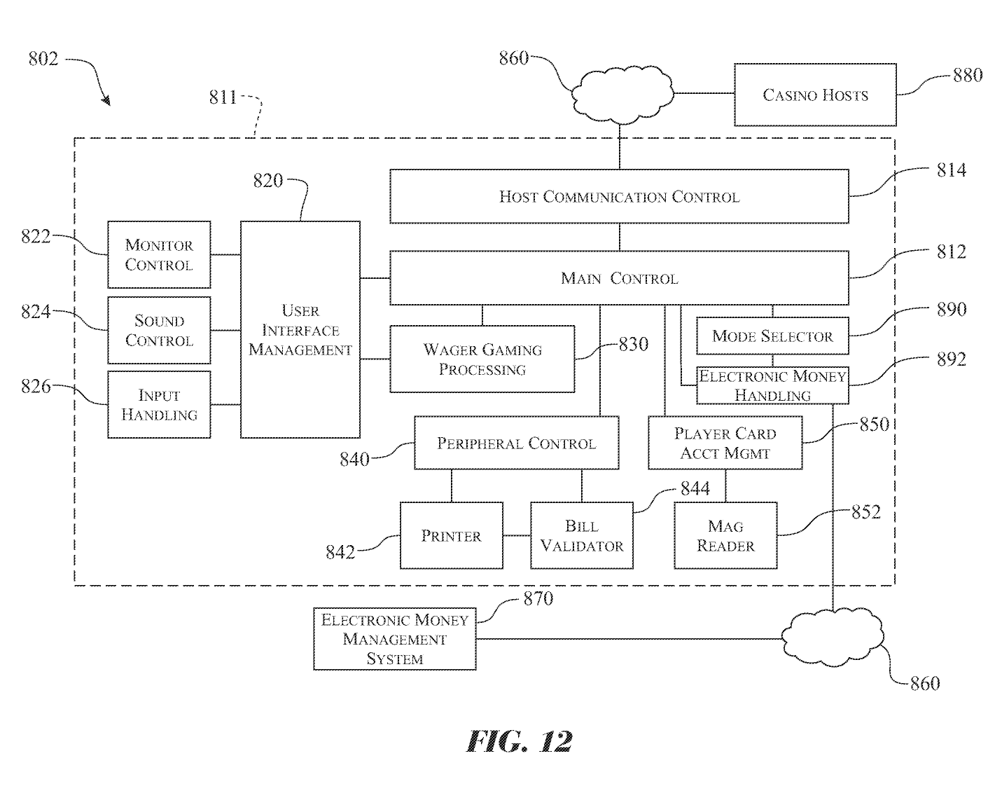

A modified exemplary modified gaming machine network 801 is illustrated in a schematic diagram format presented in FIG. 12, wherein the enhancement reconfigures the integration of the e-money processor. The gaming machine network 800 integrates the e-money processing within the bill validator 844. The modified gaming machine configuration 811 is configured for processing the e-money transaction externally from the bill validator 844. The modified gaming machine network 801 includes a modified gaming machine configuration 811. The modified gaming machine configuration 811 is a modified version of the gaming machine configuration 810, wherein the modified gaming machine configuration 811 integrates a mode selector 890. The mode selector 890 toggles between a standard bill and ticket voucher mode and an electronic financial mode. In the electronic financial mode, the mode selector 890 activates an electronic money handling system 892. The activated electronic money handling system 892 provides communication between the gaming machine main controller 812 and the electronic money management system 870.

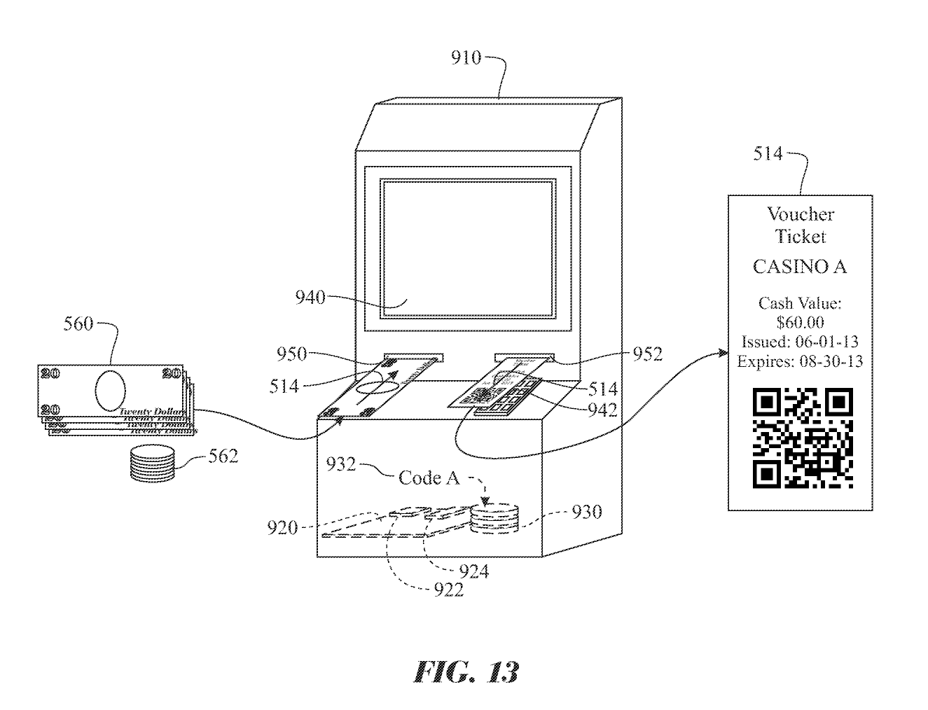

The voucher ticket system can utilize an automated system for exchanging currency 560 and coins 562, such as the exemplary voucher ticket automated processing unit 910 illustrated in FIG. 13. The voucher ticket automated processing unit 910 includes functional components for processing the currency 560 and coins 562 and dispensing a casino A voucher ticket 514 of an equivalent value. A processing circuit assembly 920 includes a central processing unit 922, a digital memory device 924, and other electrical components to form a circuit. The circuit enables functional operation of the voucher ticket automated processing unit 910. It is a general practice for each gaming facility to utilize their own custom encryption for generation of the computer readable reference (similar to the computer readable value reference 332). Small volumes of digital data can be stored within the digital memory device 924. The digital memory device 924 can be solid-state memory. Larger volumes of digital data are preferably stored in a general memory storage device 930. The general memory storage device 930 can utilize one or more disc drives, tape drives, or larger solid-state memory banks. The system would include an encoding protocol 932 or the encryption coding specific to the gaming facility. The encoding protocol 932 can be stored within the digital memory device 924, within the general memory storage device 930, or embedded within other portions of the circuit. A display monitor 940 is integrated into the voucher ticket automated processing unit 910 and provided in signal communication with the processing circuit assembly 920. The display monitor 940 provides a visual display to inform the user of any necessary steps required for the transaction as well as the status of the exchange. The display monitor 940 can be used for other options, such as marketing, and the like when the voucher ticket automated processing unit 910 is sitting idle. The display monitor 940 can be fabricated to include a touch screen function, wherein the touch screen function enables user input through a graphical user interface (GUI).

A user input device 942 is integrated into the voucher ticket automated processing unit 910 and provided in signal communication with the processing circuit assembly 920. The user input device 942 enables manual entry of data, instructions, and the like.

A bill validator and input slot 950 enables insertion of the currency 560 and coins 562 into the voucher ticket automated processing unit 910. The bill validator and input slot 950 can include a bill validator, a coin operator, and the like for ingesting, valuating, and storing the currency 560 and coins 562. The bill validator and the coin operator are in signal communication with the processing circuit assembly 920. The value of the inserted currency 560 and coins 562 is determined by the bill validator, the processing circuit assembly 920, or any other integrated component designated for the specific function. After the quantity of currency 560 and coins 562 is deposited within the bill validator and input slot 950, the voucher ticket automated processing unit 910 determines the total financial face value of the quantity of deposited currency 560 and coins 562. Upon instruction, a printed and discharge slot 952 would print and dispense the casino A voucher ticket 514, wherein the casino A voucher ticket 514 would have a value respective to the value of the inserted currency 560 and coins 562.

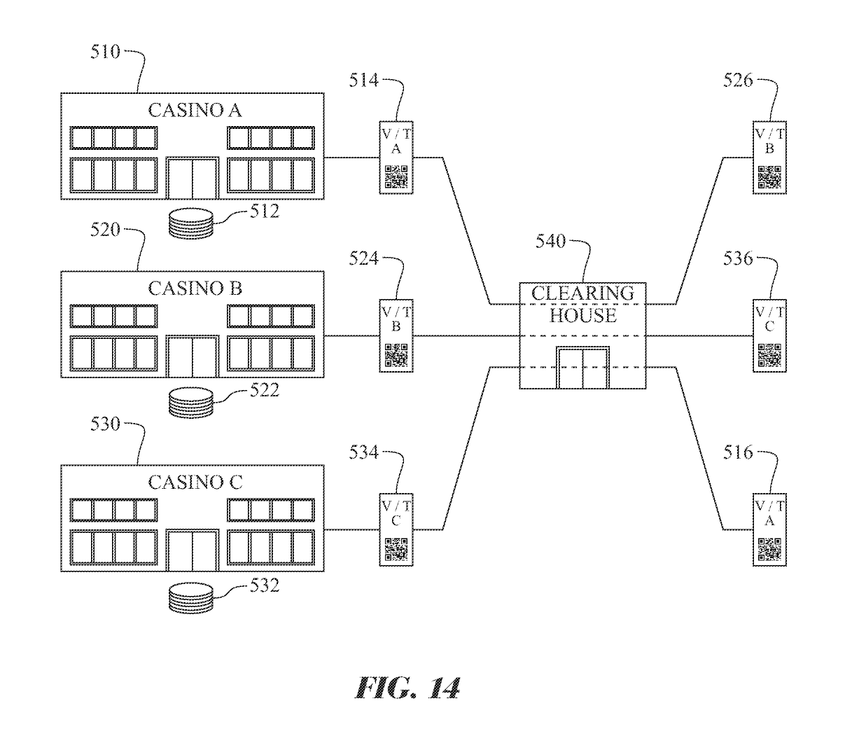

Gaming facilities 510, 520, 530 can be located independently or in clusters. Each gaming facility 510, 520, 530 provides voucher tickets 514, 524, 534 that are encrypted in accordance with the gaming facilities specific encryption coding. This scenario dictates that each voucher ticket 514, 524, 534 be used and redeemed at the respective gaming facility. Should the player desire to go to a different gaming facility 510, 520, 530, the player would have to cash out their voucher ticket(s) 514, 524, 534 at the first gaming facility, then convert the funds to a voucher ticket for another gaming facility. The implementation of a voucher ticket exchange process would reduce the two-step process to a one step process, thus giving the player more time for gaming. Variations of exchange processes are presented in FIGS. 14 through 17.

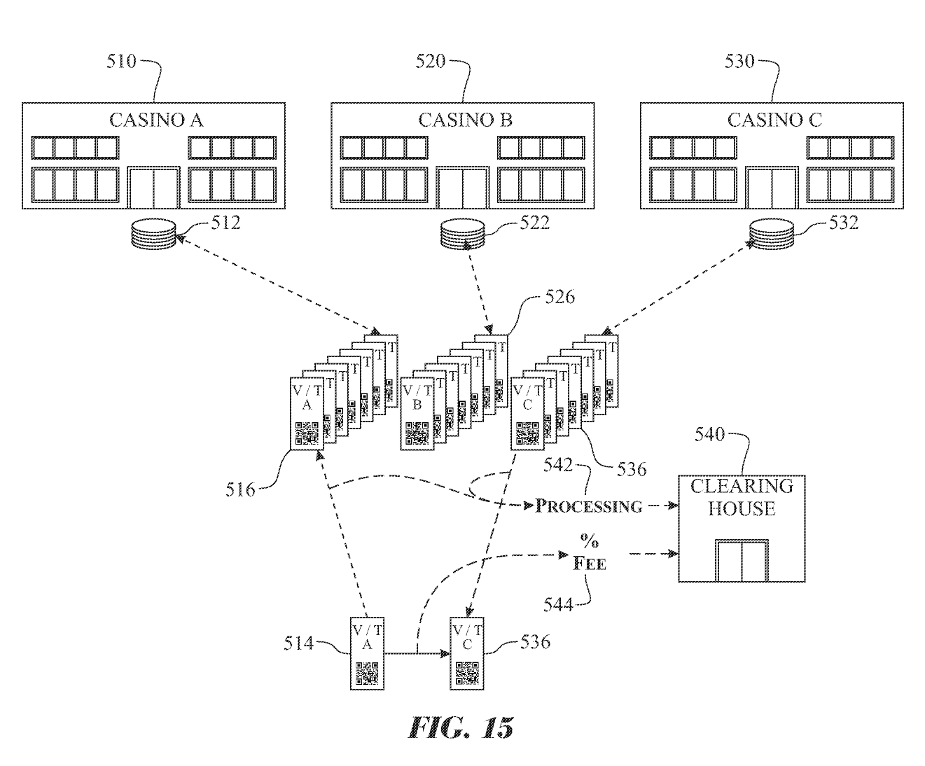

A generic conceptual schematic diagram of a voucher ticket exchange process is presented in FIG. 14. The exemplary schematic diagram utilizes three gaming facilities, a casino A 510, a casino B 520, and a casino C 530. Each gaming facility includes their own respective voucher ticket database server 512, 522, 532. Each voucher ticket database server 512, 522, 532 maintains records respective to each issued voucher ticket 514, 524, 534. The player would provide a voucher ticket clearing house 540 with the issued voucher ticket 514, 524, 534 they obtained from the gaming facility 510, 520, 530 and request one or more exchanged voucher tickets 516, 526, 536. The voucher ticket clearing house 540 would collect the issued voucher ticket 514, 524, 534 from the player and disburse the requested one or more exchanged voucher tickets 516, 526, 536. The exchanged voucher tickets 516, 526, 536 can be of a value equal to the value of the collected voucher ticket 514, 524, 534, or the voucher ticket clearing house 540 can optionally include a processing fee 544 and issue the requested one or more exchanged voucher tickets 516, 526, 536 at a value reduced by the exchange rate as suggested in FIG. 15.

A conceptual schematic diagram of a physical voucher ticket exchange process is presented in FIG. 15. The voucher ticket clearing house 540 retains an inventory of exchange voucher tickets 516, 526, 536. The voucher ticket clearing house 540 arranges a physical voucher ticket transfer program with each gaming facility 510, 520, 530. The physical voucher ticket exchange process collects the undesired issued voucher tickets 514, 524, 534 from players and distributes voucher tickets 516, 526, 536 respective to the requested casino. The voucher tickets 516, 526, 536 would be distributed to replace the undesired issued voucher tickets 514, 524, 534, wherein the voucher tickets 516, 526, 536 would be of equal or lower value than the undesired issued voucher tickets 514, 524, 534. The voucher ticket clearing house 540 would provide the processing 542. As previously mentioned, the voucher ticket clearing house 540 can include a processing fee 544 for completing the exchange. The voucher ticket clearing house 540 would retain an inventory of voucher tickets 516, 526, 536 having predetermined valuation range for each gaming facility 510, 520, 530. Each gaming facility 510, 520, 530 retains information regarding valuation, status and the like pertaining to the player held voucher tickets 516, 526, 536 and the clearing house inventory voucher tickets 516, 526, 536 in a respective voucher ticket database server 512, 522, 532. In the example presented in FIG. 15, the player is exchanging a casino A voucher ticket 514 from casino A 510 for a casino C exchanged voucher ticket 536 issued by casino C 530. The valuation of the casino C exchanged voucher ticket 536 can be equal to or less than the valuation of the casino A voucher ticket 514.

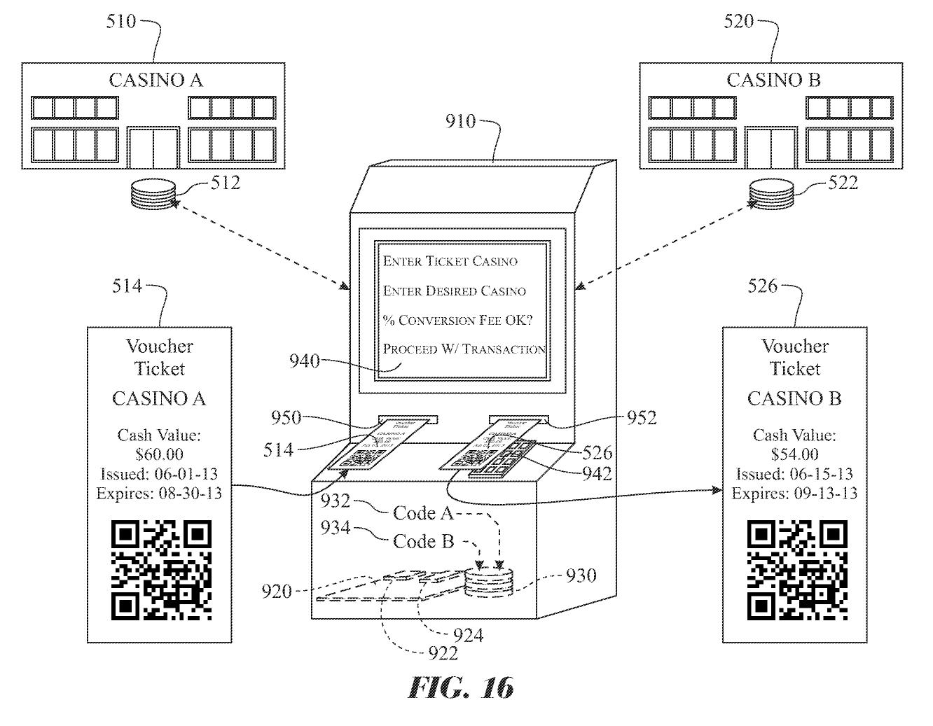

A second exemplary embodiment utilizes the voucher ticket automated processing unit 910 as an exchange machine, as illustrated in the schematic diagram presented in FIG. 16. The voucher ticket automated processing unit 910 can be operated by the player or an employee of the voucher ticket clearing house 540.

The player can enter the name of the gaming facility associated with the undesired issued voucher ticket(s) 514, 524, 534. The player also enters the name of the gaming facility associated with the desired replacement voucher tickets 516, 526, 536. In a condition where an exchange rate 544 is applied, the voucher ticket automated processing unit 910 would notify the player of the exchange rate 544 prior to completing the exchange process.

The undesired issued voucher ticket(s) 514, 524, 534 are inserted into the bill validator and input slot 950. The voucher ticket automated processing unit 910 would scan the computer readable value reference 332 of the inserted undesired issued voucher ticket(s) 514, 524, 534, decode the computer readable value reference 332, determine if the ticket is valid, and determine the value of the undesired issued voucher ticket(s) 514, 524, 534. In a condition where the exchange rate 544 is applied, the voucher ticket automated processing unit 910 would calculate a reduction in the total valuation of the inserted undesired issued voucher ticket(s) 514, 524, 534, and subsequently print and dispense a replacement voucher ticket 516, 526, 536 for use at the requested gaming facility 510, 520, 530. It is noted that the casino B exchanged voucher ticket 526 would be encoded in accordance with the respective second encoding protocol 934.

In the example presented in FIG. 16, the player is exchanging a casino A voucher ticket 514 from casino A 510 for a casino B exchanged voucher ticket 526 associated with a casino B 520. The exemplary valuation of the casino B exchanged voucher ticket 526 is reduced from the valuation of the casino A voucher ticket 514 by the voucher ticket exchange commission fee 544, wherein in the example, the commission in 10%, or $6.00. The process can additionally include a revised issued date. In the illustrated example, the casino A voucher ticket 514 was issued from casino A 510 on Jun. 1, 2013. The exchanged voucher ticket 526 associated with casino B 520 includes an issue date of Jun. 15, 2013.

The exchanged voucher ticket 526 can retain the issue date of the original voucher ticket 514 or the process can establish a new issue date, identified as a casino B exchanged electronic voucher ticket issue date 528. The process can address the issue date in any of a variety of solutions. In a first solution, the process can retain the original issue date and originally established expiration date. In a second solution, the process can increment the issue date and retain the originally established expiration date. In a third solution, the process can increment the issue date and increment the expiration date. The expiration date can be incremented by a pre-established period of time. The time period can be based upon the originally established issue date, the exchanged electronic voucher ticket issue date 528, or any other suitable time. The updated information resulting from the exchange process would be incorporated into the exchanged voucher ticket 526 and recorded at each respective voucher ticket database server 512, 522. The information can additionally be encoded in the encoded, computer or machine readable image, such as a barcode, a Quick Read or QR code, and the like. It is understood that the exchanged voucher ticket 526 can have continuously resetting expiration period, an effective indefinite expiration or exclusive of an expiration date.

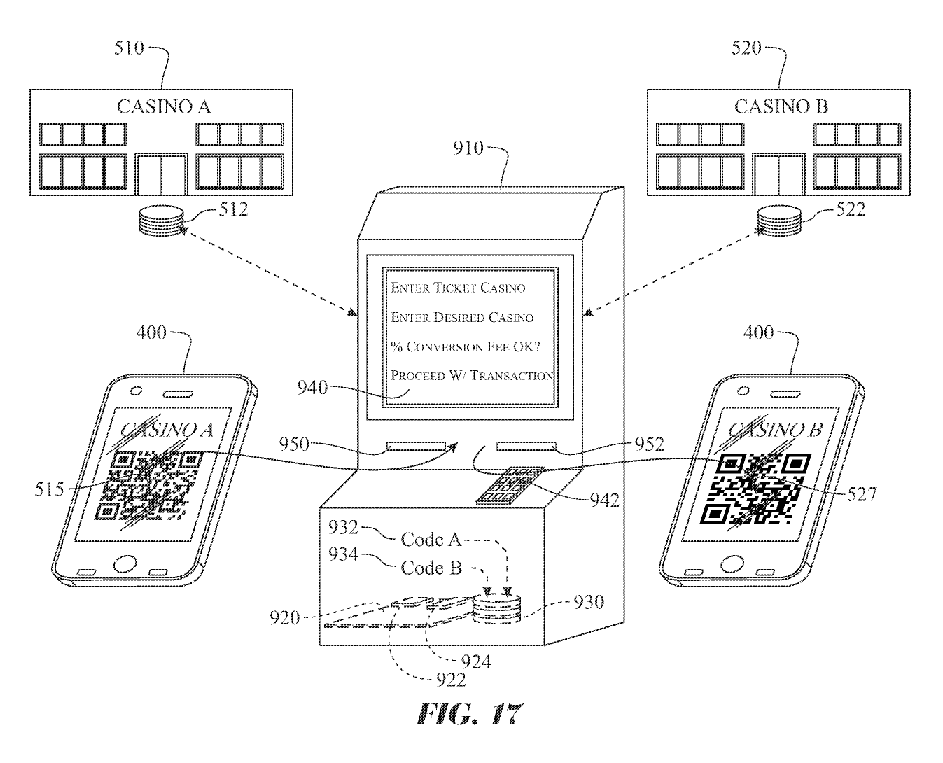

The above examples are directed towards paper voucher tickets. The same concept can be applied to the electronic voucher tickets 410, as illustrated in the exemplary schematic diagram presented in FIG. 17. The undesired issued voucher ticket(s) 514, 524, 534 are read by the voucher ticket automated processing unit 910. The reading process can be accomplished by scanning an image of a casino A electronic voucher ticket 515 displayed upon the smartphone display 404 of the smartphone 400, wireless communication between the smartphone 400 and the voucher ticket automated processing unit 910 wherein the voucher ticket is transmitted to the voucher ticket automated processing unit 910, and the like. The exchange process would include an additional step of validating the casino A electronic voucher ticket 515 with the casino A voucher ticket database server 512. The voucher ticket automated processing unit 910 would subsequently communicate with the casino B voucher ticket database server 522 to obtain or purchase a financial value for issuance of a casino B exchanged electronic voucher ticket 527. Alternatively, the voucher ticket clearing house 540 can retain an account having a value for use for issuance and credits of voucher tickets for each partnered gaming facility 510, 520, 530. The replacement voucher ticket 516, 526, 536 is conveyed to the smartphone 400 using a wired or wireless transmission. Alternatively, an image of the entire replacement voucher ticket 516, 526, 536 or a representative computer readable value reference 332 can be displayed upon the display monitor 940. The player would utilize the 4093 to obtain a digital image of the displayed information and the smartphone 400 would properly interpret and convert the acquired image into an electronic replacement voucher ticket 516, 526, 536.

In the example presented in FIG. 17, the player is exchanging a casino A electronic voucher ticket 515 from casino A 510 for a casino B exchanged electronic voucher ticket 527 associated with the casino B 520. Changes in valuation are not presented in this example.

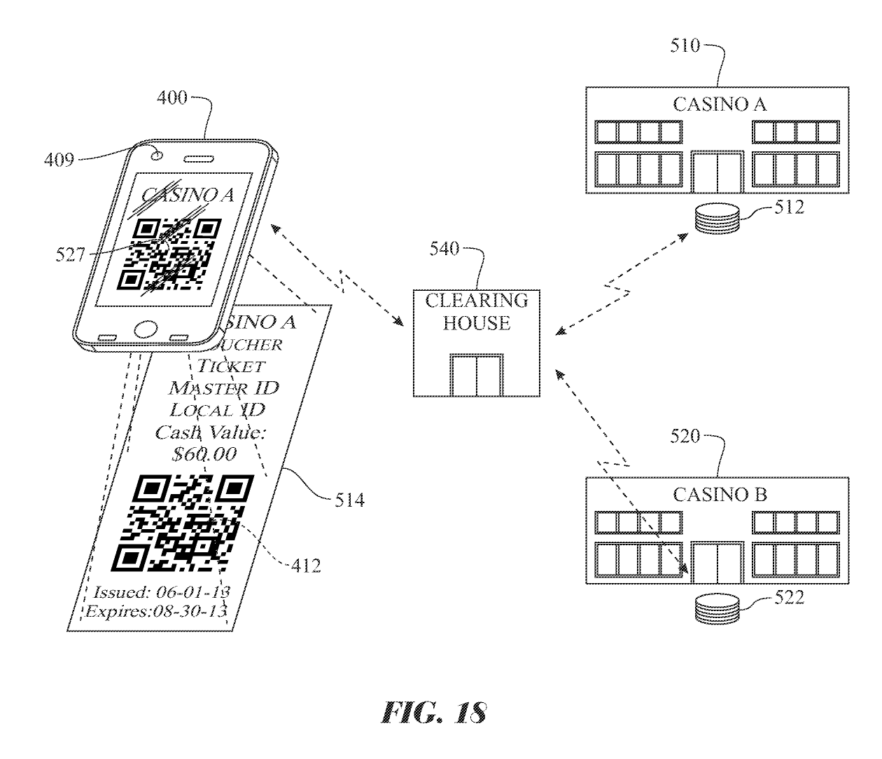

The issuing casino voucher ticket 514 can be operationally converted to an exchanged electronic voucher ticket 527 through the voucher ticket clearing house 540, as illustrated in FIG. 18. The smartphone 400 would obtain a digital image of the issuing casino voucher ticket 514 using a camera 409 integrated into the smartphone 400. The smartphone 400 would communicate a digital image or other digital representation of the issuing casino voucher ticket 514 (representing a exchanged electronic voucher ticket 527) to the voucher ticket clearing house 540. The voucher ticket clearing house 540 is in encoded digital communication with the issuing casino voucher ticket database server 512 of the issuing casino 510. The voucher ticket clearing house 540 forwards the digital representation of the exchanged electronic voucher ticket 527 to the issuing casino voucher ticket database server 512 using any secured wired or wireless communication interface. Either the voucher ticket clearing house 540 or the issuing casino voucher ticket database server 512 decodes and interprets the digital representation of the exchanged electronic voucher ticket 527 into a format that is compatible with the database of the issuing casino voucher ticket database server 512. The issuing casino voucher ticket database server 512 determines the validity of the issuing casino voucher ticket 514 (based upon the information provided as the exchanged electronic voucher ticket 527), and records data respective to a conversion of the issuing casino voucher ticket 514 to the exchanged electronic voucher ticket 527. The issuing casino voucher ticket database server 512 can optionally generate and return a revised and/or encoded image of the exchanged electronic voucher ticket 527 to the smartphone 400. This step can be used to introduce additional security measures into the process and resulting exchanged electronic voucher ticket 527. Alternatively, the issuing casino voucher ticket database server 512 would cancel the originally issued issuing casino voucher ticket 514 and generate and return a newly issued voucher in a form of a exchanged electronic voucher ticket 527.

The user can request that the voucher ticket clearing house 540 can be exchanged from the issuing Casino or other gaming facility 510 to a different, desired exchanging Casino other gaming facility 520. When being exchanged, the server 512 associated with the issuing Casino or gaming facility 510 would be notified of the exchange. The server associated with the exchanging Casino or gaming facility 520 would also be notified of the exchange. The voucher ticket clearing house 540 would arrange a transfer of funds between the issuing casino voucher ticket database server 512 and the exchanging casino voucher ticket database server 522. The process can include a fee paid to the voucher ticket clearing house 540 for their services for completing the exchange.

It is understood that the above presented exemplary exchange embodiments can be tailored by mixing process. For example, the player can insert a paper voucher ticket into the voucher ticket automated processing unit 910 and request an electronic voucher ticket as an exchanged output.

### INDUSTRIAL APPLICABILITY

The present invention is applicable to electronic payment systems for automated machines such as gaming machines, automated teller machines, vending machines, money exchangers or other money-operated equipment or apparatus.

What is claimed are:

1. A method of converting a voucher ticket issued by and associated with a first gaming facility to a voucher ticket issued by and associated with a second gaming facility, the method comprising steps of:
obtaining an originating voucher ticket having a financial value and an originating voucher ticket reference for determining said financial value, wherein said voucher ticket is issued by and associated with a first gaming facility;
storing said originating voucher ticket financial value and said originating voucher ticket reference on a first gaming facility financial server;
reading said reference from said originating voucher ticket;
determining said financial value of said originating voucher ticket by using said reference read from said originating voucher ticket and communicating with said first gaming facility financial server;
entering a desired second issuing gaming facility, wherein said second issuing gaming facility differs from said first gaming facility;
establishing a reference associated with a financial value of a replacement voucher ticket;
storing said replacement voucher ticket financial value and said replacement voucher ticket reference on a second gaming facility financial server;
issuing said replacement voucher ticket comprising said replacement voucher ticket reference.

2. The method as recited in claim 1, further comprising steps of:
encoding said originating voucher ticket reference using an encoding scheme employed by said first gaming facility;
deciphering said originating voucher ticket reference in accordance with said first gaming facility encoding scheme.

3. The method as recited in claim 2, further comprising steps of:
encoding said replacement voucher ticket reference using an encoding scheme employed by said second gaming facility;
issuing said replacement voucher ticket, wherein said replacement voucher ticket includes said replacement voucher ticket reference encoded in accordance with said second gaming facility encoding scheme.

4. The method as recited in claim 1, further comprising steps of:
encoding said replacement voucher ticket reference using an encoding scheme employed by said second gaming facility;
issuing said replacement voucher ticket, wherein said replacement voucher ticket includes said replacement voucher ticket reference encoded in accordance with said second gaming facility encoding scheme.

5. The method as recited in claim 1, further comprising steps of:
issuing said at least one of said originating voucher ticket and said replacement voucher ticket in an electronic format.

6. The method as recited in claim 5, further comprising steps of:
issuing said electronic formatted voucher ticket by wirelessly communicating a digital image of said electronic formatted voucher ticket to a portable computing device.

7. The method as recited in claim 1, wherein said originating voucher ticket is provided in a printed format; further comprising a step of:
issuing said replacement voucher ticket in an electronic format.

8. A method of converting a voucher ticket issued by and associated with a first gaming facility to a voucher ticket issued by and associated with a second gaming facility, the method comprising steps of:
obtaining an originating voucher ticket having a financial value and an originating voucher ticket reference for determining said financial value, wherein said voucher ticket is issued by and associated with a first gaming facility, wherein said originating voucher ticket reference is provided in a first machine readable format;
storing said originating voucher ticket financial value and said originating voucher ticket reference on a first gaming facility financial server;
reading said reference from said originating voucher ticket using a voucher ticket reader, wherein said voucher ticket reader is respective to a format used for conveying said reference from said originating voucher ticket;
determining said financial value of said originating voucher ticket by using said reference read from said originating voucher ticket and communicating with said first gaming facility financial server;
entering a desired second issuing gaming facility, wherein said second issuing gaming facility differs from said first gaming facility;
establishing a reference associated with a financial value of a replacement voucher ticket;
storing said replacement voucher ticket financial value and said replacement voucher ticket reference on a second gaming facility financial server;
issuing said replacement voucher ticket comprising said replacement voucher ticket reference, wherein said replacement voucher ticket reference is provided in a second machine readable format, wherein said first machine readable format and said second machine readable format can be in like or different formats.

9. The method as recited in claim 8, further comprising steps of:
encoding said originating voucher ticket reference using an encoding scheme employed by said first gaming facility;
deciphering said originating voucher ticket reference in accordance with said first gaming facility encoding scheme.

10. The method as recited in claim 9, further comprising steps of:
encoding said replacement voucher ticket reference using an encoding scheme employed by said second gaming facility;
issuing said replacement voucher ticket, wherein said replacement voucher ticket includes said replacement voucher ticket reference encoded in accordance with said second gaming facility encoding scheme.

11. The method as recited in claim 8, further comprising steps of:
encoding said replacement voucher ticket reference using an encoding scheme employed by said second gaming facility;
issuing said replacement voucher ticket, wherein said replacement voucher ticket includes said replacement voucher ticket reference encoded in accordance with said second gaming facility encoding scheme.

12. The method as recited in claim 8, further comprising steps of:
issuing said at least one of said originating voucher ticket and said replacement voucher ticket in an electronic format.

13. The method as recited in claim 12, further comprising steps of:
issuing said electronic formatted voucher ticket by wirelessly communicating a digital image of said electronic formatted voucher ticket to a portable computing device.

14. The method as recited in claim 8, wherein said originating voucher ticket is provided in a printed format; further comprising a step of:
issuing said replacement voucher ticket in an electronic format.

15. A method of converting a voucher ticket issued by and associated with a first gaming facility to a voucher ticket issued by and associated with a second gaming facility, the method comprising steps of:
obtaining an originating voucher ticket having a financial value and an originating voucher ticket reference for determining said financial value, wherein said voucher ticket is issued by and associated with a first gaming facility, wherein said originating voucher ticket reference is provided in a first machine readable format;
storing said originating voucher ticket financial value and said originating voucher ticket reference on a first gaming facility financial server;
reading said reference from said originating voucher ticket using a voucher ticket reader, wherein said voucher ticket reader is respective to a format used for conveying said reference from said originating voucher ticket;
determining said financial value of said originating voucher ticket by using said reference read from said originating voucher ticket and communicating with said first gaming facility financial server;
entering a desired second issuing gaming facility, wherein said second issuing gaming facility differs from said first gaming facility;
establishing a reference associated with a financial value of a replacement voucher ticket;
storing said replacement voucher ticket financial value and said replacement voucher ticket reference on a second gaming facility financial server;
issuing said replacement voucher ticket comprising said replacement voucher ticket reference, wherein said replacement voucher ticket reference is provided in a second machine readable format, wherein said first machine readable format and said second machine readable format can be in like or different formats,
wherein at least one of said first machine readable format and said second machine readable format is a barcode format.

16. The method as recited in claim 15, further comprising steps of:
encoding said originating voucher ticket reference using an encoding scheme employed by said first gaming facility;
deciphering said originating voucher ticket reference in accordance with said first gaming facility encoding scheme.

17. The method as recited in claim 16, further comprising steps of:
encoding said replacement voucher ticket reference using an encoding scheme employed by said second gaming facility;
issuing said replacement voucher ticket, wherein said replacement voucher ticket includes said replacement voucher ticket reference encoded in accordance with said second gaming facility encoding scheme.

18. The method as recited in claim 15, further comprising steps of:
encoding said replacement voucher ticket reference using an encoding scheme employed by said second gaming facility;
issuing said replacement voucher ticket, wherein said replacement voucher ticket includes said replacement voucher ticket reference encoded in accordance with said second gaming facility encoding scheme.

19. The method as recited in claim 15, further comprising steps of:
issuing said at least one of said originating voucher ticket and said replacement voucher ticket in an electronic format.

20. The method as recited in claim 19, further comprising steps of:
issuing said electronic formatted voucher ticket by wirelessly communicating a digital image of said electronic formatted voucher ticket to a portable computing device.

21. The method as recited in claim 15, wherein said originating voucher ticket is provided in a printed format; further comprising a step of:
issuing said replacement voucher ticket in an electronic format.
